(19) United States
(12) Patent Application Publication
(10) Pub. No.: US 2022/0179177 A1
(43) Pub. Date: Jun. 9, 2022

(54) IMAGING LENS

(71) Applicant: TOKYO VISIONARY OPTICS CO., LTD., Tokyo (JP)

(72) Inventors: Zhiyu HUANG, Tokyo (JP); Masaya HASHIMOTO, Tokyo (JP)

(21) Appl. No.: 17/364,087

(22) Filed: Jun. 30, 2021

(30) Foreign Application Priority Data
Jun. 30, 2020 (JP) 2020-112815

(51) Int. Cl. G02B 13/00; G02B 9/62

(52) U.S. Cl. CPC G02B 13/0045; G02B 9/62

(57) ABSTRACT

There is provided an imaging lens with excellent optical characteristics which satisfies demand of a low profile and a low F-number. An imaging lens comprises in order from an object side to an image side, a first lens with positive refractive power, a second lens with negative refractive power, a third lens with positive or negative refractive power, a fourth lens with positive refractive power, a fifth lens, and a sixth lens with negative refractive power, wherein said first lens has an object-side surface being convex in a paraxial region, said sixth lens has an image-side surface being concave in a paraxial region, and predetermined conditional expressions are satisfied.

### BACKGROUND OF THE INVENTION

### Field of the Invention

The present invention relates to an imaging lens which forms an image of an object on a solid-state image sensor such as a CCD sensor or a C-MOS sensor used in an imaging device.

### Description of the Related Art

In recent years, it becomes common that camera function is mounted in various products, such as information terminal equipment, home appliances, automobiles, and the like. Development of products with the camera function will be made accordingly.

The imaging lens mounted in such equipment is required to be compact and to have high-resolution performance.

As a conventional imaging lens aiming high performance, for example, the imaging lens disclosed in the following Patent Document 1 has been known.

Patent Document 1 (CN110346908A) discloses an imaging lens in order from an object side, a first lens, a second lens with positive refractive power, a third lens with negative refractive power, a fourth lens, a fifth lens, and a sixth lens, wherein a relationship between a focal length of the first lens and a focal length of the second lens, and a relationship between a curvature radius of an object-side surface of the second lens and a curvature radius of an image-side surface of the second lens satisfy certain conditions.

### SUMMARY OF THE INVENTION

However, in lens configurations disclosed in the Patent Document 1, when a low profile and a low F-number are to be realized, it is very difficult to correct aberrations at a peripheral area, and excellent optical performance can not be obtained.

The present invention has been made in view of the above-described problems, and an object of the present invention is to provide an imaging lens with high resolution which satisfies demand of the low profile and the low F-number in well balance and excellently corrects aberrations.

Regarding terms used in the present invention, “a convex surface (a surface being convex)”, “a concave surface (a surface being concave)” or “a flat surface (a surface being flat)” of lens surfaces implies a shape of the lens surface in a paraxial region (near the optical axis). “Refractive power” implies the refractive power in a paraxial region. “A pole point” implies an off-axial point on an aspheric surface at which a tangential plane intersects the optical axis perpendicularly. “A total track length” is defined as a distance along the optical axis from an object-side surface of an optical element located closest to the object to an image plane. “The total track length” and “a back focus” is a distance obtained when thickness of an IR cut filter or a cover glass which may be arranged between the imaging lens and the image plane is converted into an air-converted distance.

### Means for Solving Problems

An imaging lens according to the present invention comprises, in order from an object side to an image side, a first lens with positive refractive power, a second lens with negative refractive power, a third lens with positive or negative refractive power, a fourth lens with positive refractive power, a fifth lens, and a sixth lens with negative refractive power, wherein said first lens has an object-side surface being convex in a paraxial region, and said sixth lens has an image-side surface being concave in a paraxial region.

The first lens has the positive refractive power, aspheric surfaces on both sides, and the object-side surface being convex in a paraxial region. Therefore, spherical aberration, coma aberration, astigmatism, field curvature, and distortion are suppressed.

The second lens has the negative refractive power and aspheric surfaces on both sides, and chromatic aberration, the astigmatism, the field curvature, and the distortion are properly corrected.

The third lens has the positive or the negative refractive power and aspheric surfaces on both sides. When the third lens has the positive refractive power, the spherical aberration, the astigmatism, the field curvature, and the distortion are properly corrected. When the third lens has the negative refractive power, the chromatic aberration, the astigmatism, the field curvature, and the distortion are properly corrected.

The fourth lens has the positive refractive power and aspheric surfaces on both sides. Therefore, reduction in a profile is achieved and the coma aberration, the astigmatism, the field curvature, and distortion are suppressed.

The fifth lens has aspheric surfaces on both sides, and the astigmatism, the field curvature, and the distortion are properly corrected.

The sixth lens has the negative refractive power and aspheric surfaces on both sides, and the chromatic aberration, the astigmatism, the field curvature, and the distortion are properly corrected. Furthermore, the sixth lens has the image-side surface being concave in the paraxial region, and maintains a low profile and secures a back focus.

According to the imaging lens having the above-described configuration, it is preferable that an image-side surface of the first lens is concave in the paraxial region.

When the image-side surface of the first lens is concave in the paraxial region, the astigmatism and the distortion are properly corrected.

According to the imaging lens having the above-described configuration, it is preferable that an object-side surface of the second lens is convex in the paraxial region.

When the object-side surface of the second lens is convex in the paraxial region, the astigmatism, the field curvature, and the distortion are properly corrected.

According to the imaging lens having the above-described configuration, it is preferable that an image-side surface of the second lens is concave in the paraxial region.

When the image-side surface of the second lens is concave in the paraxial region, the astigmatism, the field curvature, and the distortion are properly corrected.

According to the imaging lens having the above-described configuration, it is preferable that an image-side surface of the fourth lens is convex in the paraxial region.

When the image-side surface of the fourth lens is convex in the paraxial region, the coma aberration, the astigmatism, the field curvature, and the distortion are properly corrected.

According to the imaging lens having the above-described configuration, it is preferable that an object-side surface of the sixth lens is convex in the paraxial region.

When the object-side surface of the sixth lens is convex in the paraxial region, the astigmatism, the field curvature, and the distortion are properly corrected.

According to the imaging lens having the above-described configuration, it is preferable that the object-side surface of the sixth lens is formed as an aspheric surface having at least one pole point in a position off the optical axis.

When the object-side surface of the sixth lens is formed as an aspheric surface having at least one pole point in a position off the optical axis, the astigmatism, the field curvature, and the distortion are more properly corrected.

According to the imaging lens having the above-described configuration, it is preferable that the image-side surface of the sixth lens is formed as an aspheric surface having at least one pole point in a position off the optical axis.

When the image-side surface of the sixth lens is formed as an aspheric surface having at least one pole point in a position off the optical axis, the astigmatism, the field curvature, and the distortion are more properly corrected.

The imaging lens according to the present invention, due to the above-mentioned configuration, achieves a low profile which a ratio of a total track length to a diagonal length of an effective image area of the image sensor is 0.7 or less and a low F number of 2.0 or less.

According to the imaging lens having the above-described configuration, it is preferable that the following conditional expression (1) is satisfied:

11.00<vd3<26.00 (1)

where

vd3: an abbe number at d-ray of the third lens.

The conditional expression (1) defines an appropriate range of the abbe number at d-ray of the third lens. By satisfying the conditional expression (1), the chromatic aberration can be properly corrected.

According to the imaging lens having the above-described configuration, it is preferable that the following conditional expression (2) is satisfied:

0.10<(r2/|r6|)×100<100.00 (2)

where

r2: a paraxial curvature radius of an image-side surface of the first lens, and

r6: a paraxial curvature radius of an image-side surface of the third lens.

The conditional expression (2) defines an appropriate range of a relationship between the paraxial curvature radius of the image-side surface of the first lens and the paraxial curvature radius of the image-side surface of the third lens. By satisfying the conditional expression (2), the astigmatism, the field curvature, and the distortion can be properly corrected.

According to the imaging lens having the above-described configuration, it is preferable that the following conditional expression (3) is satisfied:

1.60<(|r5/r6|)×100 (3)

where

r5: a paraxial curvature radius of an object-side surface of the third lens, and

r6: a paraxial curvature radius of an image-side surface of the third lens.

The conditional expression (3) defines an appropriate range of a relationship between the paraxial curvature radius of the object-side surface of the third lens and the paraxial curvature radius of the image-side surface of the third lens. By satisfying the conditional expression (3), the astigmatism, the field curvature, and the distortion can be properly corrected.

According to the imaging lens having the above-described configuration, it is preferable that the following conditional expression (4) is satisfied:

0.50<r11/(T4+D5+T5)<6.75 (4)

where

r11: a paraxial curvature radius of an object-side surface of the sixth lens,

T4: a distance along the optical axis from an image-side surface of the fourth lens to an object-side surface of the fifth lens,

D5: a thickness along the optical axis of the fifth lens, and

T5: a distance along the optical axis from an image-side surface of the fifth lens to an object-side surface of the sixth lens.

The conditional expression (4) defines an appropriate range of a relationship among the paraxial curvature radius of the object-side surface of the sixth lens, the distance along the optical axis from the image-side surface of the fourth lens to the object-side surface of the fifth lens, the thickness along the optical axis of the fifth lens, and the distance along the optical axis from the image-side surface of the fifth lens to the object-side surface of the sixth lens. By satisfying the conditional expression (4), reduction in the profile can be achieved, and the coma aberration, the astigmatism, the field curvature, and the distortion can be properly corrected.

According to the imaging lens having the above-described configuration, it is preferable that the following conditional expression (5) is satisfied:

0.05<(r2/r4/|r6|)×100<7.00 (5)

where

r2: a paraxial curvature radius of an image-side surface of the first lens,

r4: a paraxial curvature radius of an image-side surface of the second lens, and

r6: a paraxial curvature radius of an image-side surface of the third lens.

The conditional expression (5) defines an appropriate range of a relationship among the paraxial curvature radius of the image-side surface of the first lens, the paraxial curvature radius of the image-side surface of the second lens, and the paraxial curvature radius of the image-side surface of the third lens. By satisfying the conditional expression (5), the astigmatism, the field curvature, and the distortion can be properly corrected.

According to the imaging lens having the above-described configuration, it is preferable that the following conditional expression (6) is satisfied:

−5.00<r3/f2<−1.00 (6)

where

r3: a paraxial curvature radius of an object-side surface of the second lens, and

f2: a focal length of the second lens.

The conditional expression (6) defines an appropriate range of a relationship between the paraxial curvature radius of the object-side surface of the second lens and the focal length of the second lens. By satisfying the conditional expression (6), the chromatic aberration, the astigmatism, the field curvature, and the distortion can be properly corrected.

According to the imaging lens having the above-described configuration, it is preferable that the following conditional expression (7) is satisfied:

3.25<r3/(T2/T1)<11.50 (7)

where

r3: a paraxial curvature radius of an object-side surface of the second lens,

T2: a distance along the optical axis from an image-side surface of the second lens to an object-side surface of the third lens, and

T1: a distance along the optical axis from an image-side surface of the first lens to an object-side surface of the second lens.

The conditional expression (7) defines an appropriate range of a relationship among the paraxial curvature radius of the object-side surface of the second lens, the distance along the optical axis from the image-side surface of the second lens to the object-side surface of the third lens, and the distance along the optical axis from the image-side surface of the first lens to the object-side surface of the second lens. By satisfying the conditional expression (7), reduction in the profile can be achieved, and the astigmatism, the field curvature, and the distortion can be properly corrected.

According to the imaging lens having the above-described configuration, it is preferable that the following conditional expression (8) is satisfied:

33.00<vd4<77.00 (8)

where

vd4: an abbe number at d-ray of the fourth lens.

The conditional expression (8) defines an appropriate range of the abbe number at d-ray of the fourth lens. By satisfying the conditional expression (8), the chromatic aberration can be properly corrected.

According to the imaging lens having the above-described configuration, it is preferable that the following conditional expression (9) is satisfied:

7.75<f4/D4<90.00 (9)

where

f4: a focal length of the fourth lens,

D4: a thickness along the optical axis of the fourth lens.

The conditional expression (9) defines an appropriate range of a relationship between the focal length of the fourth lens and the thickness along the optical axis of the fourth lens. By satisfying the conditional expression (9), reduction in the profile can be achieved, and the coma aberration, the astigmatism, the field curvature, and the distortion can be properly corrected.

According to the imaging lens having the above-described configuration, it is preferable that the following conditional expression (10) is satisfied:

8.00<(f1/f4)×100<65.00 (10)

where

f1: a focal length of the first lens, and

f4: a focal length of the fourth lens.

The conditional expression (10) defines an appropriate range of a relationship between the focal length of the first lens and the focal length of the fourth lens. By satisfying the conditional expression (10), reduction in the profile can be achieved, and the spherical aberration, the coma aberration, the astigmatism, the field curvature, and the distortion can be properly corrected.

According to the imaging lens having the above-described configuration, it is preferable that the following conditional expression (11) is satisfied:

9.50<|r6|/r12 (11)

where

r6: a paraxial curvature radius of an image-side surface of the third lens, and

r12: a paraxial curvature radius of an image-side surface of the sixth lens.

The conditional expression (11) defines an appropriate range of a relationship between the paraxial curvature radius of the image-side surface of the third lens and the paraxial curvature radius of the image-side surface of the sixth lens. By satisfying the conditional expression (11), the astigmatism, the field curvature, and the distortion can be properly corrected.

According to the imaging lens having the above-described configuration, it is preferable that the following conditional expression (12) is satisfied:

1.50<r3/r4<9.00 (12)

where

r3: a paraxial curvature radius of an object-side surface of the second lens, and

r4: a paraxial curvature radius of an image-side surface of the second lens.

The conditional expression (12) defines an appropriate range of a relationship between the paraxial curvature radius of the object-side surface of the second lens and the paraxial curvature radius of the image-side surface of the second lens. By satisfying the conditional expression (12), the astigmatism, the field curvature, and the distortion can be properly corrected.

According to the imaging lens having the above-described configuration, it is preferable that the following conditional expression (13) is satisfied:

0.30<(r4/|r6|)×100<38.75 (13)

where

r4: a paraxial curvature radius of an image-side surface of the second lens, and

r6: a paraxial curvature radius of an image-side surface of the third lens.

The conditional expression (13) defines an appropriate range of a relationship between the paraxial curvature radius of the image-side surface of the second lens and the paraxial curvature radius of the image-side surface of the third lens. By satisfying the conditional expression (13), the astigmatism, the field curvature, and the distortion can be properly corrected.

According to the imaging lens having the above-described configuration, it is preferable that the following conditional expression (14) is satisfied:

−2.50<r8/r11<−0.40 (14)

where

r8: a paraxial curvature radius of an image-side surface of the fourth lens, and

r11: a paraxial curvature radius of an object-side surface of the sixth lens.

The conditional expression (14) defines an appropriate range of a relationship between the paraxial curvature radius of the image-side surface of the fourth lens and the paraxial curvature radius of the object-side surface of the sixth lens. By satisfying the conditional expression (14), the coma aberration, the astigmatism, the field curvature, and the distortion can be properly corrected.

According to the imaging lens having the above-described configuration, it is preferable that the following conditional expression (15) is satisfied:

1.00<r11/r12<4.50 (15)

where

r11: a paraxial curvature radius of an object-side surface of the sixth lens, and

r12: a paraxial curvature radius of an image-side surface of the sixth lens.

The conditional expression (15) defines an appropriate range of a relationship between the paraxial curvature radius of the object-side surface of the sixth lens and the paraxial curvature radius of the image-side surface of the sixth lens. By satisfying the conditional expression (15), the astigmatism, the field curvature, and the distortion can be properly corrected.

According to the imaging lens having the above-described configuration, it is preferable that the following conditional expression (16) is satisfied:

2.30<r3/f<14.00 (16)

where

r3: a paraxial curvature radius of an object-side surface of the second lens, and

f: a focal length of the overall optical system of the imaging lens.

The conditional expression (16) defines an appropriate range of the paraxial curvature radius of the object-side surface of the second lens. By satisfying the conditional expression (16), the astigmatism, the field curvature, and the distortion can be properly corrected.

According to the imaging lens having the above-described configuration, it is preferable that the following conditional expression (17) is satisfied:

10.00<r4/T2<30.00 (17)

where

r4: a paraxial curvature radius of an image-side surface of the second lens, and

T2: a distance along the optical axis from an image-side surface of the second lens to an object-side surface of the third lens.

The conditional expression (17) defines an appropriate range of a relationship between the paraxial curvature radius of the image-side surface of the second lens and the distance along the optical axis from the image-side surface of the second lens to the object-side surface of the third lens. By satisfying the conditional expression (17), reduction in the profile can be achieved, and the astigmatism, the field curvature, and the distortion can be properly corrected.

According to the imaging lens having the above-described configuration, it is preferable that the following conditional expression (18) is satisfied:

2.10<|r5|/f (18)

where

r5: a paraxial curvature radius of an object-side surface of the third lens, and

f: a focal length of the overall optical system of the imaging lens.

The conditional expression (18) defines an appropriate range of the paraxial curvature radius of the object-side surface of the third lens. By satisfying the conditional expression (18), the astigmatism, the field curvature, and the distortion can be properly corrected.

According to the imaging lens having the above-described configuration, it is preferable that the following conditional expression (19) is satisfied:

47.00<|r6|/D3 (19)

where

r6: a paraxial curvature radius of an image-side surface of the third lens, and

D3: a thickness along the optical axis of the third lens.

The conditional expression (19) defines an appropriate range of a relationship between the paraxial curvature radius of the image-side surface of the third lens and the thickness along the optical axis of the third lens. By satisfying the conditional expression (19), reduction in the profile can be achieved, and the astigmatism, the field curvature, and the distortion can be properly corrected.

According to the imaging lens having the above-described configuration, it is preferable that the following conditional expression (20) is satisfied:

0.20<r11/f<1.35 (20)

where

r11: a paraxial curvature radius of an object-side surface of the sixth lens, and

f: a focal length of the overall optical system of the imaging lens.

The conditional expression (20) defines an appropriate range of the paraxial curvature radius of the object-side surface of the sixth lens. By satisfying the conditional expression (20), the astigmatism, the field curvature, and the distortion can be properly corrected.

According to the imaging lens having the above-described configuration, it is preferable that the following conditional expression (21) is satisfied:

4.15<|r6|/r11 (21)

where

r6: a paraxial curvature radius of an image-side surface of the third lens, and

r11: a paraxial curvature radius of an object-side surface of the sixth lens.

The conditional expression (21) defines an appropriate range of a relationship between the paraxial curvature radius of the image-side surface of the third lens and the paraxial curvature radius of the object-side surface of the sixth lens. By satisfying the conditional expression (21), the astigmatism, the field curvature, and the distortion can be properly corrected.

According to the imaging lens having the above-described configuration, it is preferable that the following conditional expression (22) is satisfied:

18.50<|r6|/(T2+D3) (22)

where

r6: a paraxial curvature radius of an image-side surface of the third lens,

T2: a distance along the optical axis from an image-side surface of the second lens to an object-side surface of the third lens, and

D3: a thickness along the optical axis of the third lens.

The conditional expression (22) defines an appropriate range of a relationship among the paraxial curvature radius of the image-side surface of the third lens, the distance along the optical axis from the image-side surface of the second lens to the object-side surface of the third lens, and the thickness along the optical axis of the third lens. By satisfying the conditional expression (22), reduction in the profile can be achieved, and the astigmatism, the field curvature, and the distortion can be properly corrected.

According to the imaging lens having the above-described configuration, it is preferable that the following conditional expression (23) is satisfied:

0.32<r12/r11<1.00 (23)

where

r12: a paraxial curvature radius of an image-side surface of the sixth lens, and

r11: a paraxial curvature radius of an object-side surface of the sixth lens.

The conditional expression (23) defines an appropriate range of a relationship between the paraxial curvature radius of the object-side surface of the sixth lens and the paraxial curvature radius of the image-side surface of the sixth lens. By satisfying the conditional expression (23), the astigmatism, the field curvature, and the distortion can be properly corrected.

According to the imaging lens having the above-described configuration, it is preferable that the following conditional expression (24) is satisfied:

2.50<r11/D6<12.00 (24)

where

r11: a paraxial curvature radius of an object-side surface of the sixth lens, and

D6: a thickness along the optical axis of the sixth lens.

According to the imaging lens having the above-described configuration, it is preferable that the following conditional expression (25) is satisfied:

0.75<r4/(T2/T1)<3.50 (25)

where

r4: a paraxial curvature radius of an image-side surface of the second lens,

T2: a distance along the optical axis from an image-side surface of the second lens to an object-side surface of the third lens, and

T1: a distance along the optical axis from an image-side surface of the first lens to an object-side surface of the second lens.

### Effect of Invention

According to the present invention, there can be provided an imaging lens with high resolution which satisfies demand of the low profile and the low F-number in well balance, and properly corrects aberrations.

### BRIEF DESCRIPTION OF THE DRAWINGS

FIG. 1 is a schematic view showing an imaging lens in Example 1 according to the present invention.

FIG. 2 shows spherical aberration, astigmatism, and distortion of the imaging lens in Example 1 according to the present invention.

FIG. 3 is a schematic view showing an imaging lens in Example 2 according to the present invention.

FIG. 4 shows spherical aberration, astigmatism, and distortion of the imaging lens in Example 2 according to the present invention.

FIG. 5 is a schematic view showing an imaging lens in Example 3 according to the present invention.

FIG. 6 shows spherical aberration, astigmatism, and distortion of the imaging lens in Example 3 according to the present invention.

FIG. 7 is a schematic view showing an imaging lens in Example 4 according to the present invention.

FIG. 8 shows spherical aberration, astigmatism, and distortion of the imaging lens in Example 4 according to the present invention.

FIG. 9 is a schematic view showing an imaging lens in Example 5 according to the present invention.

FIG. 10 shows spherical aberration, astigmatism, and distortion of the imaging lens in Example 5 according to the present invention.

FIG. 11 is a schematic view showing an imaging lens in Example 6 according to the present invention.

FIG. 12 shows spherical aberration, astigmatism, and distortion of the imaging lens in Example 6 according to the present invention.

FIG. 13 is a schematic view showing an imaging lens in Example 7 according to the present invention.

FIG. 14 shows spherical aberration, astigmatism, and distortion of the imaging lens in Example 7 according to the present invention.

FIG. 15 is a schematic view showing an imaging lens in Example 8 according to the present invention.

FIG. 16 shows spherical aberration, astigmatism, and distortion of the imaging lens in Example 8 according to the present invention.

FIG. 17 shows spherical aberration, astigmatism, and distortion of the imaging lens in Example 9 according to the present invention.

FIG. 18 is a schematic view showing an imaging lens in Example 9 according to the present invention.

### DETAILED DESCRIPTION OF THE PREFERRED EMBODIMENT

Hereinafter, the preferred embodiment of the present invention will be described in detail referring to the accompanying drawings.

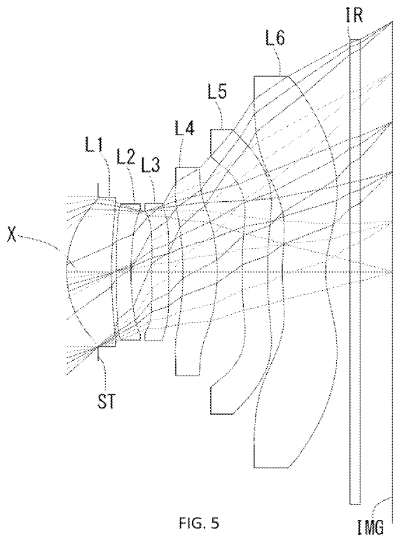

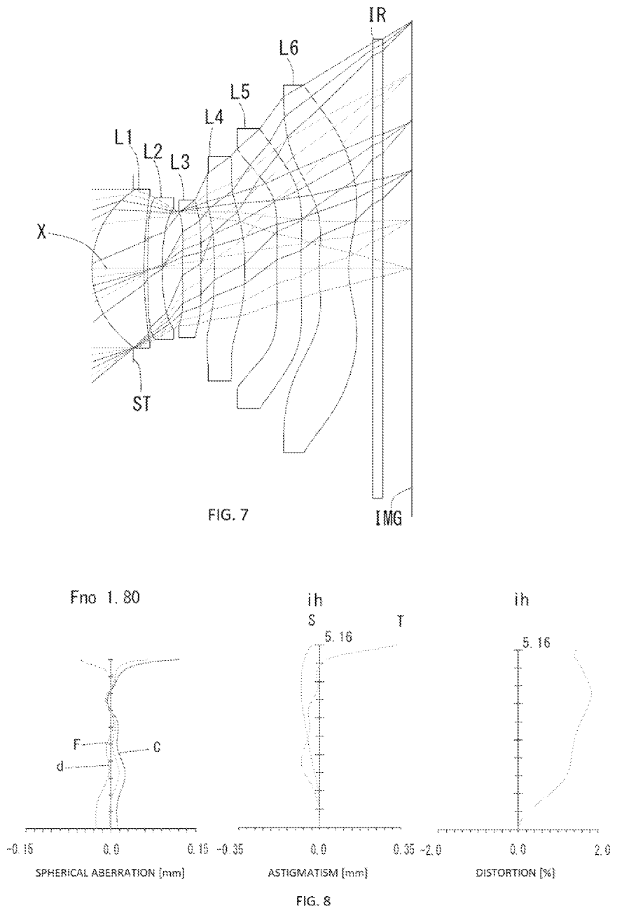

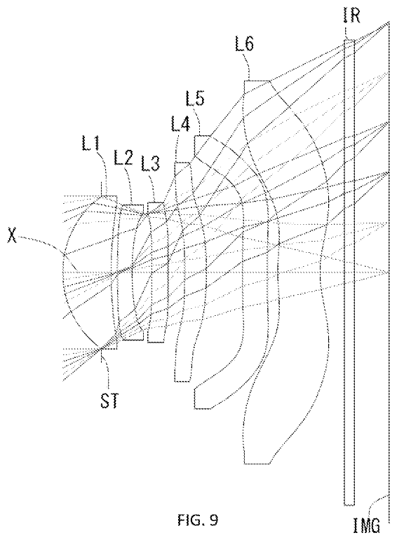

FIGS. 1, 3, 5, 7, 9, 11, 13, 15 and 17 are schematic views of the imaging lenses in Examples 1 to 9 according to the embodiments of the present invention, respectively.

The imaging lens according to the present invention comprises, in order from an object side to an image side, a first lens L1 with positive refractive power, a second lens L2 with negative refractive power, a third lens L3 with positive or negative refractive power, a fourth lens L4 with positive refractive power, a fifth lens L5, and a sixth lens L6 with negative refractive power, wherein said first lens L1 has an object-side surface being convex in a paraxial region, and said sixth lens L6 has an image-side surface being concave in a paraxial region.

A filter IR such as an IR cut filter or a cover glass is arranged between the sixth lens L6 and an image plane IMG (namely, the image plane of an image sensor). The filter IR is omissible.

By arranging an aperture stop ST on the object side of the first lens L1, correction of aberrations and control of an incident angle of the light ray of high image height to an image sensor become facilitated.

The first lens L1 has the positive refractive power and is formed in a meniscus shape having the object-side surface being convex and an image-side surface being concave in the paraxial region. Therefore, spherical aberration, coma aberration, astigmatism, field curvature, and distortion are suppressed.

The second lens L2 has the negative refractive power and is formed in a meniscus shape having an object-side surface being convex and an image-side surface being concave in the paraxial region. Furthermore, both surfaces of the second lens L2 are aspheric surfaces. Therefore, chromatic aberration, the astigmatism, the field curvature, and the distortion are properly corrected.

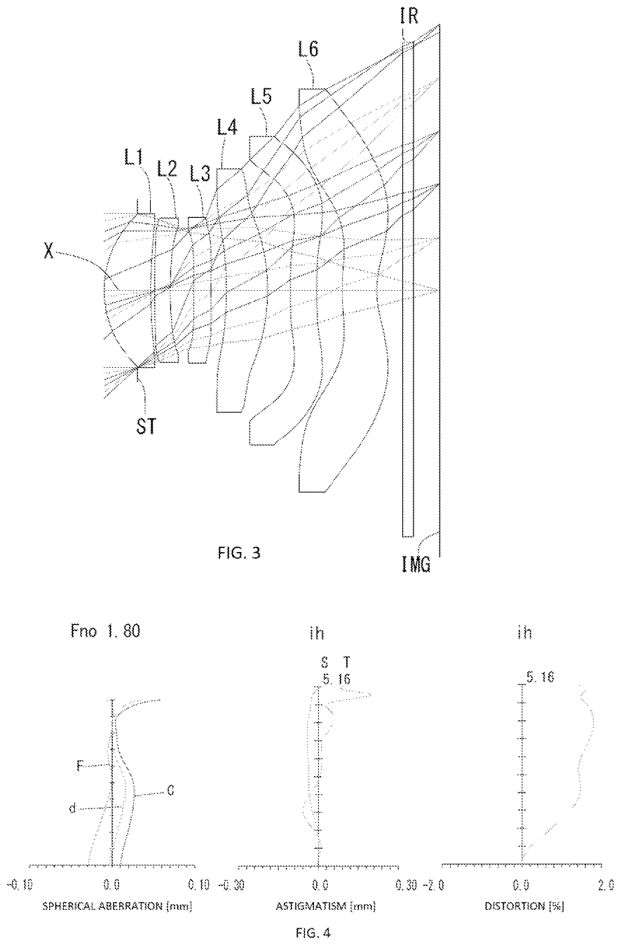

The third lens L3 has the positive refractive power as in Examples 1, 3, 4, 5, 6 and 9 shown in FIGS. 1, 5, 7, 9, 11 and 17. On the other hand, the third lens L3 has the negative refractive power as in Examples 2, 7 and 8 shown in FIGS. 3, 13 and 15. When the third lens L3 has the positive refractive power, the spherical aberration, the astigmatism, the field curvature, and the distortion can be properly corrected. When the third lens L3 has the negative refractive power, the chromatic aberration, the astigmatism, the field curvature, and the distortion can be properly corrected.

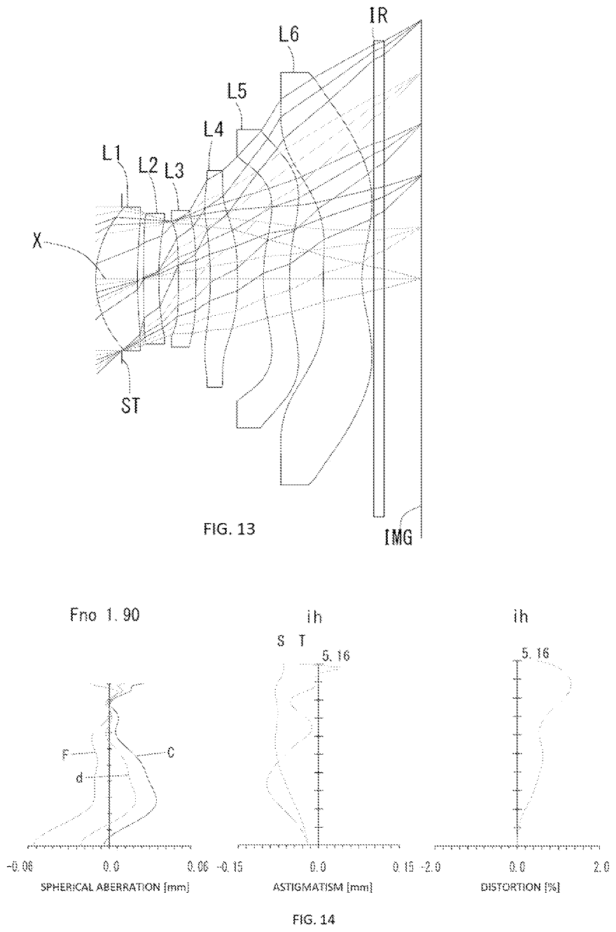

The third lens L3 is formed in a biconvex shape having an object-side surface being convex and an image-side surface being convex in the paraxial region as in Example 1 shown in FIG. 1. Furthermore, the third lens L3 is formed in a meniscus shape having the object-side surface being convex and the image-side surface being concave in the paraxial region as in Examples 2, 3, 4, 5, 8 and 9 shown in FIGS. 3, 5, 7, 9, 15 and 17. Additionally, the third lens L3 is formed in a meniscus shape having the object-side surface being concave and the image-side surface being convex in the paraxial region as in Examples 6 and 7 shown in FIGS. 11 and 13. In the all of Examples, both surfaces of the third lens L3 are aspheric surfaces. When the third lens L3 is formed in a biconvex shape in the paraxial region, the spherical aberration, the astigmatism, the field curvature, and the distortion can be properly corrected. When the third lens L3 is formed in the meniscus shape having the object-side surface being convex and the image-side surface being concave, the astigmatism, the field curvature, and the distortion can be properly corrected. When the third lens L3 is formed in the meniscus shape having the object-side surface being concave and the image-side surface being convex in the paraxial region, the astigmatism, the field curvature, and the distortion can be properly corrected.

The fourth lens L4 has the positive refractive power and is formed in a meniscus shape having the object-side surface being concave and an image-side surface being convex in the paraxial region. Furthermore, both surfaces of the fourth lens L4 are aspheric surfaces. Therefore, the coma aberration, the astigmatism, the field curvature, and the distortion are properly corrected.

The fifth lens L5 substantially has no refractive power, and is formed in a shape having an object-side surface and an image-side surface which are both flat in a paraxial region. Furthermore, both surfaces of the fifth lens L5 are aspheric surfaces. Therefore, the astigmatism, the field curvature, and the distortion are properly corrected without affecting a focal length of the overall optical system of the imaging lens.

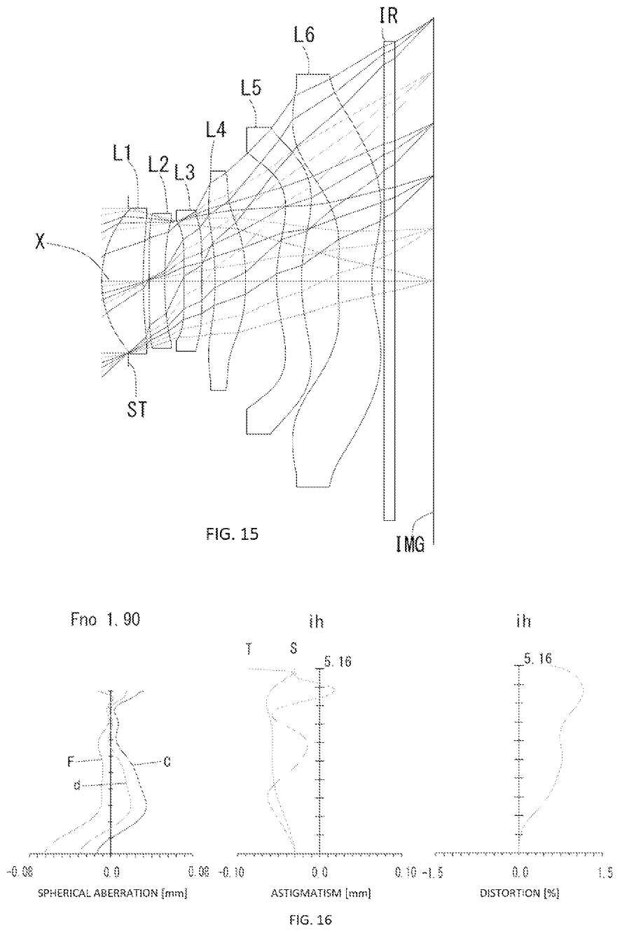

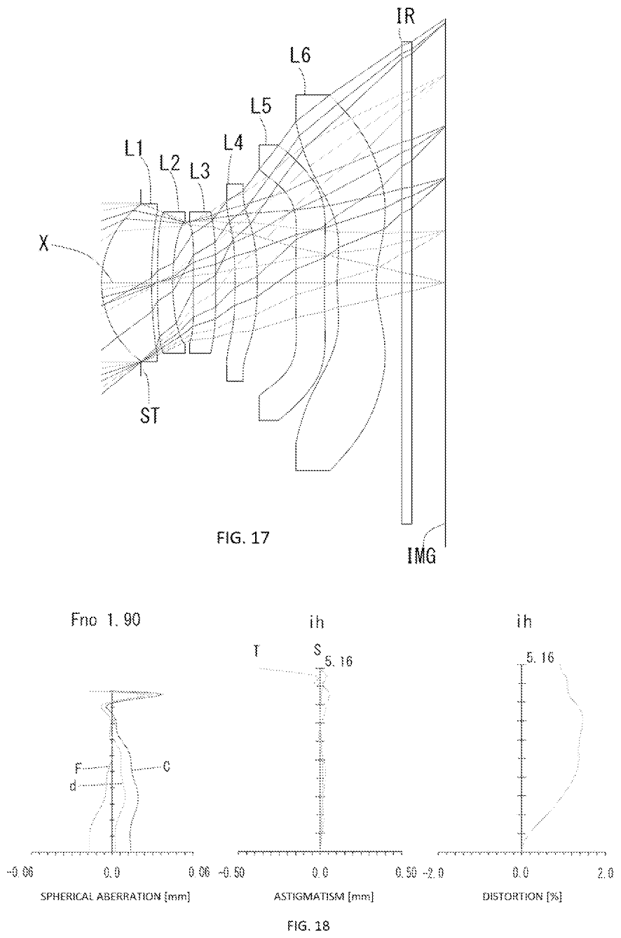

Refractive power of the fifth lens L5 may be negative as in Examples 6 and 9 shown in FIGS. 11 and 17. In this case, the fifth lens L5 is favorable for correction of the chromatic aberration. Furthermore, the fifth lens L5 may have the positive refractive power as in Examples 7 and 8 shown in FIGS. 13 and 15. In this case, the fifth lens L5 is favorable for correction of the spherical aberration.

The fifth lens L5 may be formed in a meniscus shape having an object-side surface being convex and an image-side surface being concave in the paraxial region as in Examples 6, 7 and 8 shown in FIGS. 11, 13 and 15. In this case, the astigmatism, the field curvature, and the distortion can be properly corrected. Furthermore, the fifth lens L5 may be formed in a meniscus shape having the object-side surface being concave and the image-side surface being convex as in Example 9 shown in FIG. 17. In this case, the astigmatism, the field curvature, and the distortion are properly corrected.

The sixth lens L6 has the negative refractive power, and is formed in a meniscus shape having an object-side surface being convex and the image-side surface being concave in the paraxial region. Furthermore, both surfaces of the sixth lens L6 are aspheric surfaces. Therefore, the chromatic aberration, the astigmatism, the field curvature, and the distortion are corrected. Due to the image-side surface of the sixth lens L6 being concave in the paraxial region, a back focus is secured while maintaining the low profile.

The object-side surface of the sixth lens L6 is formed as an aspheric surface having at least one pole point in a position off the optical axis X. Therefore, the astigmatism, the field curvature, and the distortion are properly corrected.

The image-side surface of the sixth lens L6 is formed as an aspheric surface having at least one pole point in a position off the optical axis X. Therefore, the astigmatism, the field curvature, and the distortion are more properly corrected.

Regarding the imaging lens according to the present embodiments, it is preferable that all lenses of the first lens L1 to the sixth lens L6 are single lenses. Configuration only with the single lenses can frequently use the aspheric surfaces. In the present embodiments, all lens surfaces are formed as appropriate aspheric surfaces, and the aberrations are properly corrected. Furthermore, in comparison with the case in which a cemented lens is used, workload is reduced, and manufacturing in low cost becomes possible.

Furthermore, the imaging lens according to the present embodiments makes manufacturing facilitated by using a plastic material for the lenses, and mass production in a low cost can be realized.

The material applied to the lens is not limited to the plastic material. By using glass material, further high performance may be aimed. It is preferable that all of lens-surfaces are formed as aspheric surfaces, however, spherical surfaces easy to be manufactured may be applied in accordance with required performance.

The imaging lens according to the present embodiments shows preferable effects by satisfying the following conditional expressions (1) to (25),

11.00<vd3<26.00 (1)

0.10<(r2/|r6|)×100<100.00 (2)

1.60<(|r5/r6|)×100 (3)

0.50<r11/(T4+D5+T5)<6.75 (4)

0.05<(r2/r4/|r6|)×100<7.00 (5)

−5.00<r3/f2<−1.00 (6)

3.25<r3/(T2/T1)<11.50 (7)

33.00<vd4<77.00 (8)

7.75<f4/D4<90.00 (9)

8.00<(f1/f4)×100<65.00 (10)

9.50<|r6|/r12 (11)

1.50<r3/r4<9.00 (12)

0.30<(r4/|r6|)×100<38.75 (13)

−2.50<r8/r11<−0.40 (14)

1.00<r11/r12<4.50 (15)

2.30<r3/f<14.00 (16)

10.00<r4/T2<30.00 (17)

2.10<|r5|/f (18)

47.00<|r6|/D3 (19)

0.20<r11/f<1.35 (20)

4.15<|r6|/r11 (21)

18.50<|r6|/(T2+D3) (22)

0.32<r12/r11<1.00 (23)

2.50<r11/D6<12.00 (24)

0.75<r4/(T2/T1)<3.50 (25)

where
vd3: an abbe number at d-ray of the third lens L3,
vd4: an abbe number at d-ray of the fourth lens L4,
D3: a thickness along the optical axis X of the third lens L3,
D4: a thickness along the optical axis X of the fourth lens L4,
D5: a thickness along the optical axis X of the fifth lens L5,
D6: a thickness along the optical axis X of the sixth lens L6,
T1: a distance along the optical axis X from an image-side surface of the first lens L1 to an object-side surface of the second lens L2.
T2: a distance along the optical axis X from an image-side surface of the second lens L2 to an object-side surface of the third lens L3,
T4: a distance along the optical axis X from an image-side surface of the fourth lens L4 to an object-side surface of the fifth lens L5,
T5: a distance along the optical axis X from an image-side surface of the fifth lens L5 to an object-side surface of the sixth lens L6, f: a focal length of the overall optical system of the imaging lens,
f1: a focal length of the first lens L1,
f2: a focal length of the second lens L2,
f4: a focal length of the fourth lens L4,
r2: a paraxial curvature radius of an image-side surface of the first lens L1,
r3: a paraxial curvature radius of an object-side surface of the second lens L2,
r4: a paraxial curvature radius of an image-side surface of the second lens L2,
r5: a paraxial curvature radius of an object-side surface of the third lens L3,
r6: a paraxial curvature radius of an image-side surface of the third lens L3,
r8: a paraxial curvature radius of an image-side surface of the fourth lens L4,
r11: a paraxial curvature radius of an object-side surface of the sixth lens L6, and
r12: a paraxial curvature radius of an image-side surface of the sixth lens L6.

It is not necessary to satisfy the above all conditional expressions. An operational advantage corresponding to each conditional expression can be obtained by satisfying the conditional expression individually.

The imaging lens according to the present embodiments shows further preferable effects by satisfying the following conditional expressions (1a) to (25a),

15.50<vd3<23.00 (1a)

0.40<(r2/|r6|)×100<65.00 (2a)

2.20<(|r5/r6|)×100<300.00 (3a)

1.75<r11/(T4+D5+T5)<5.30 (4a)

0.08<(r2/r4/|r6|)×100<6.25 (5a)

−4.00<r3/f2<−1.20 (6a)

3.95<r3/(T2/T1)<10.25 (7a)

45.00<vd4<67.00 (8a)

10.75<f4/D4<74.00 (9a)

12.50<(f1/f4)×100<53.00 (10a)

10.50<|r6|/r12<1000.00 (11a)

2.30<r3/r4<7.20 (12a)

0.50<(r4/|r6|)×100<35.50 (13a)

−2.00<r8/r11<−0.50 (14a)

1.50<r11/r12<3.50 (15a)

2.65<r3/f<11.50 (16a)

11.00<r4/T2<25.00 (17a)

2.70<|r5|/f<550.00 (18a)

57.00<|r6|/D3<4000.00 (19a)

0.50<r11/f<1.20 (20a)

4.65<|r6|/r11<350.00 (21a)

25.00<|r6|/(T2+D3)<2000.00 (22a)

0.35<r12/r11<0.75 (23a)

3.70<r11/D6<10.50 (24a)

0.90<r4/(T2/T1)<2.85. (25a)

The signs in the above conditional expressions have the same meanings as those in the paragraph before the preceding paragraph. Additionally, only lower limits or upper limits of the conditional expressions (1a) to (25a) may be applied to the corresponding conditional expressions (1) to (25).

In this embodiment, the aspheric shapes of the aspheric surfaces of the lens are expressed by Equation 1, where Z denotes an axis in the optical axis direction, H denotes a height perpendicular to the optical axis, R denotes a paraxial curvature radius, k denotes a conic constant, and A4, A6, A8, A10, A12, A14, A16, A18 and A20 denote aspheric surface coefficients.

$$Z = \frac{\frac{{H}^{2}}{R}}{1 + \sqrt{1 - ( k + 1 ) \frac{{H}^{2}}{{R}^{2}}}} + {A}_{4} {H}^{4} + {A}_{6} {H}^{6} + {A}_{8} {H}^{8} + {A}_{10} {H}^{10} + {A}_{12} {H}^{12} + {A}_{14} {H}^{14} + {A}_{16} {H}^{16} + {A}_{18} {H}^{18} + {A}_{20} {H}^{20} \qquad [ Equation 1 ]$$

Next, examples of the imaging lens according to this embodiment will be explained. In each example, f denotes a focal length of the overall optical system of the imaging lens, Fno denotes an F-number, ω denotes a half field of view, ih denotes a maximum image height, and TTL denotes a total track length. Additionally, i denotes a surface number counted from the object side, r denotes a paraxial curvature radius, d denotes a distance of lenses along the optical axis (surface distance), Nd denotes a refractive index at d-ray (reference wavelength), and vd denotes an abbe number at d-ray. As for aspheric surfaces, an asterisk (*) is added after surface number i.

### Example 1

The basic lens data is shown below in Table 1.

TABLE 1
Example 1
Unit mm
f = 5.53
Fno = 1.80
ω(°) = 42.6
ih = 5.15
TTL = 6.43
Surface Data

| i | r | d | Nd | υd |
|---|---|---|---|---|
| (Object) | Infinity | Infinity | | |
| 1 (Stop) | Infinity | −0.6044 | | |
| 2* | 1.9535 | 0.9294 | 1.535 | 55.69 (υd1) |
| 3* | 8.4328 | 0.0655 | | |
| 4* | 39.9432 | 0.3020 | 1.671 | 19.24 (υd2) |
| 5* | 7.5315 | 0.4592 | | |
| 6* | 30.5278 | 0.3880 | 1.671 | 19.24 (υd3) |
| 7* | −1094.1270 | 0.4124 | | |
| 8* | −4.5576 | 0.8516 | 1.535 | 55.69 (υd4) |
| 9* | −2.8605 | 0.1864 | | |
| 10* | Infinity | 0.5500 | 1.671 | 19.24 (υd5) |
| 11* | Infinity | 0.5190 | | |
| 12* | 5.1070 | 0.6103 | 1.535 | 55.69 (υd6) |
| 13* | 1.8200 | 0.5000 | | |
| 14 | Infinity | 0.2100 | 1.517 | 64.20 |
| 15 | Infinity | 0.5152 | | |
| Image Plane | | | | |

Constituent Lens Data

| | | | TTL to diagonal length of |
|---|---|---|---|
| Lens | Start Surface | Focal Length | effective image area |
| 1 | 2 | 4.528 | 0.62 |
| 2 | 4 | −13.890 | |
| 3 | 6 | 44.284 | |
| 4 | 8 | 12.226 | |
| 5 | 10 | Infinity | |
| 6 | 12 | −5.653 | |

Aspheric Surface Data

| | 2nd Surface | 3rd Surface | 4th Surface | 5th Surface | 6th Surface | 7th Surface |
|---|---|---|---|---|---|---|
| k | −6.359972E−02 | 0.000000E+00 | 0.000000E+00 | 0.000000E+00 | 0.000000E+00 | 0.000000E+00 |
| A4 | 4.907319E−04 | −1.433200E−03 | 3.663400E−03 | 2.066389E−02 | −2.489145E−02 | −3.780391E−02 |
| A6 | 4.451312E−03 | −4.474653E−02 | 1.361665E−02 | 6.740700E−02 | −7.366401E−02 | 1.975961E−02 |
| A8 | −3.261859E−03 | 5.668187E−02 | −8.164936E−02 | −3.224967E−01 | 1.676895E−01 | −4.276897E−02 |
| A10 | 6.491730E−04 | −3.845419E−02 | 1.911654E−01 | 8.535289E−01 | −2.589972E−01 | 3.305796E−02 |
| A12 | 4.824866E−04 | 1.500199E−02 | −2.186186E−01 | −1.266637E+00 | 2.309366E−01 | −5.165502E−03 |
| A14 | −2.893872E−04 | −3.205033E−03 | 1.453181E−01 | 1.132917E+00 | −1.105189E−01 | −8.559030E−03 |
| A16 | −1.182512E−06 | 2.411678E−04 | −5.697466E−02 | −6.047643E−01 | 1.824731E−02 | 6.455498E−03 |
| A18 | −1.087569E−05 | 5.219266E−06 | 1.233841E−02 | 1.776518E−01 | 5.227314E−03 | −1.762789E−03 |
| A20 | −7.552888E−11 | 1.290474E−06 | −1.135324E−03 | −2.188646E−02 | −1.940087E−03 | 1.609298E−04 |
| | 8th Surface | 9th Surface | 10th Surface | 11th Surface | 12th Surface | 13th Surface |
| k | 0.000000E+00 | −4.138947E+00 | 0.000000E+00 | 0.000000E+00 | −5.309583E+01 | −6.677944E+00 |
| A4 | −3.364416E−02 | −1.881420E−02 | 7.115592E−02 | 8.663580E−02 | −4.890985E−02 | −3.719550E−02 |
| A6 | 4.008420E−02 | −5.316132E−03 | −7.765038E−02 | −7.341666E−02 | −5.336760E−03 | 3.036599E−03 |
| A8 | −4.477280E−02 | −3.992946E−03 | 3.296939E−02 | 2.829289E−02 | 4.996454E−03 | 5.004398E−04 |
| A10 | 2.594459E−02 | 6.771611E−03 | −8.735201E−03 | −6.587840E−03 | −9.628791E−04 | −1.998610E−04 |
| A12 | −4.669659E−03 | −2.494103E−03 | 1.746617E−03 | 9.575890E−04 | 9.042194E−05 | 3.117799E−05 |
| A14 | −1.206123E−03 | 3.884498E−04 | −3.199645E−04 | −8.510223E−05 | −4.340683E−06 | −2.782329E−06 |
| A16 | 6.644538E−04 | −2.054898E−05 | 4.668867E−05 | 4.304337E−06 | 7.707238E−08 | 1.450256E−07 |
| A18 | −1.072169E−04 | −1.062433E−06 | −3.961122E−06 | −1.045117E−07 | 1.343576E−09 | −4.047311E−09 |
| A20 | 6.158584E−06 | 1.194947E−07 | 1.367098E−07 | 7.236789E−10 | −5.435528E−11 | 4.609383E−11 |

The imaging lens in Example 1 achieves a ratio of a total track length to a diagonal length of an effective image area of the image sensor of 0.62, and a F number of 1.80. As shown in Table 10, the imaging lens in Example 1 satisfies the conditional expressions (1) to (25).

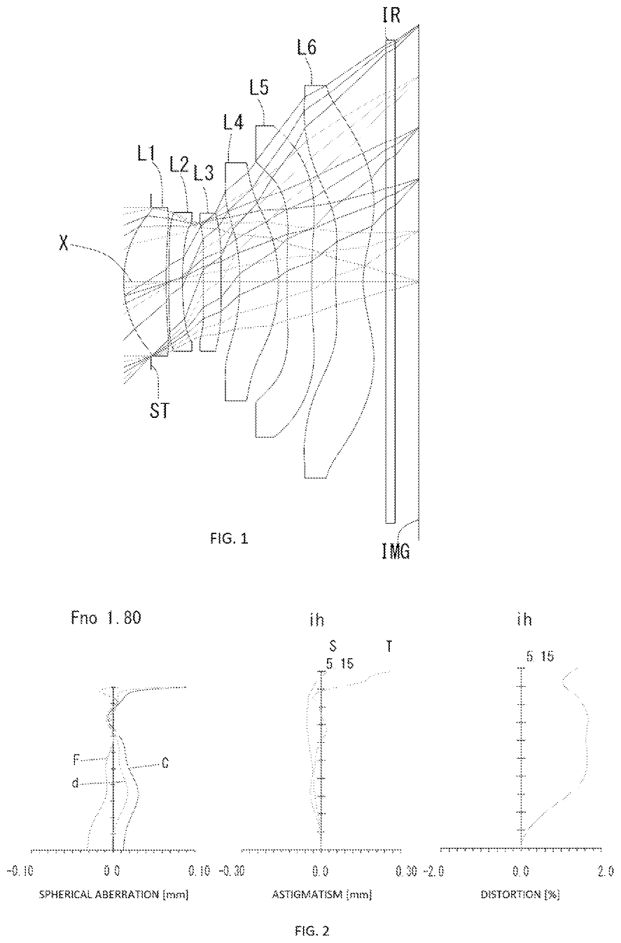

FIG. 2 shows spherical aberration (mm), astigmatism (mm), and distortion (%) of the imaging lens in Example 1. The spherical aberration diagram shows the amount of aberration at each wavelength of F-ray (486 nm), d-ray (588 nm), and C-ray (656 nm). The astigmatism diagram shows the amount of aberration at d-ray on a sagittal image surface S (solid line) and the amount of aberration at d-ray on tangential image surface T (broken line), respectively (same as FIGS. 4, 6, 8, 10, 12, 14, 16 and 18). As shown in FIG. 2, each aberration is corrected excellently.

### Example 2

The basic lens data is shown below in Table 2.

TABLE 2
Example 2
Unit mm
f = 5.55
Fno = 1.80
ω(°) = 42.5
ih = 5.16
TTL = 6.43
Surface Data

| i | r | d | Nd | υd |
|---|---|---|---|---|
| (Object) | Infinity | Infinity | | |
| 1 (Stop) | Infinity | −0.6468 | | |
| 2* | 2.0124 | 0.9026 | 1.535 | 55.69 (υd1) |
| 3* | 8.6807 | 0.0800 | | |
| 4* | 50.1532 | 0.3020 | 1.671 | 19.24 (υd2) |
| 5* | 8.7554 | 0.4488 | | |
| 6* | 29.7639 | 0.3400 | 1.671 | 19.24 (υd3) |
| 7* | 27.0498 | 0.2970 | | |
| 8* | −6.7235 | 0.7991 | 1.535 | 55.69 (υd4) |
| 9* | −3.2956 | 0.4406 | | |
| 10* | Infinity | 0.5113 | 1.671 | 19.24 (υd5) |
| 11* | Infinity | 0.4968 | | |
| 12* | 4.5827 | 0.6659 | 1.535 | 55.69 (υd6) |
| 13* | 1.7691 | 0.5000 | | |
| 14 | Infinity | 0.2100 | 1.517 | 64.20 |
| 15 | Infinity | 0.5058 | | |
| Image Plane | | | | |

Constituent Lens Data

| | | | TTL to diagonal length of |
|---|---|---|---|
| Lens | Start Surface | Focal Length | effective image area |
| 1 | 2 | 4.678 | 0.62 |
| 2 | 4 | −15.860 | |
| 3 | 6 | −465.663 | |
| 4 | 8 | 11.178 | |
| 5 | 10 | Infinity | |
| 6 | 12 | −5.872 | |

Aspheric Surface Data

| | 2nd Surface | 3rd Surface | 4th Surface | 5th Surface | 6th Surface | 7th Surface |
|---|---|---|---|---|---|---|
| k | −9.835823E−03 | 0.000000E+00 | 0.000000E+00 | 0.000000E+00 | 0.000000E+00 | 0.000000E+00 |
| A4 | −3.412790E−04 | 1.649234E−03 | 8.329629E−03 | 2.770968E−02 | −2.026151E−02 | −1.648391E−02 |
| A6 | 4.496141E−03 | −3.460576E−02 | −2.277324E−02 | −8.063940E−02 | −1.625812E−01 | −4.750287E−02 |
| A8 | −2.858166E−03 | 4.539856E−02 | 3.233502E−02 | 2.809205E−01 | 4.532870E−01 | −1.114724E−02 |
| A10 | 4.800682E−04 | −2.999317E−02 | −2.372002E−03 | −5.452724E−01 | −8.606340E−01 | 1.598266E−01 |
| A12 | 4.027294E−04 | 1.071915E−02 | −2.615362E−02 | 6.726999E−01 | 1.067094E+00 | −2.859077E−01 |
| A14 | −1.680254E−04 | −2.088907E−03 | 2.677268E−02 | −5.233307E−01 | −8.647632E−01 | 2.619427E−01 |
| A16 | 8.401617E−06 | 1.996922E−04 | −1.257223E−02 | 2.464783E−02 | 4.399766E−01 | −1.345653E−01 |
| A18 | −6.600859E−06 | 1.766778E−05 | 3.048095E−03 | −6.332847E−02 | −1.267787E−01 | 3.692935E−02 |
| A20 | −2.240634E−06 | −9.332837E−06 | −3.005920E−04 | 6.711306E−03 | 1.565087E−02 | −4.210665E−03 |
| | 8th Surface | 9th Surface | 10th Surface | 11th Surface | 12th Surface | 13th Surface |
| k | 0.000000E+00 | −7.524118E+00 | 0.000000E+00 | 0.000000E+00 | 0.000000E+00 | −6.316347E+00 |
| A4 | 4.687272E−02 | 6.803563E−02 | 1.736831E−01 | 1.592417E−01 | −1.008314E−01 | −5.140887E−02 |
| A6 | −1.222935E−01 | −1.420317E−01 | −1.895629E−01 | −1.455365E−01 | 1.854306E−02 | 1.219076E−02 |
| A8 | 1.676840E−01 | 1.278744E−01 | 1.095606E−01 | 7.025194E−02 | −4.116703E−03 | −3.238221E−03 |
| A10 | −1.629549E−01 | −7.620840E−02 | −4.392462E−02 | −2.283656E−02 | 1.242955E−03 | 6.860842E−04 |
| A12 | 1.078194E−01 | 3.151407E−02 | 1.210607E−02 | 5.070895E−03 | −2.368972E−04 | −9.193466E−05 |
| A14 | −4.483053E−02 | −8.488029E−03 | −2.208474E−03 | −7.532512E−04 | 2.564735E−05 | 7.390241E−06 |
| A16 | 1.110184E−02 | 1.390157E−03 | 2.505238E−04 | 7.134503E−05 | −1.584720E−06 | −3.435772E−07 |
| A18 | −1.494857E−03 | −1.249562E−04 | −1.579802E−05 | −3.884687E−06 | 5.250528E−08 | 8.424496E−09 |
| A20 | 8.421452E−05 | 4.717682E−06 | 4.200872E−07 | 9.225098E−08 | −7.266615E−10 | −8.289099E−11 |

The imaging lens in Example 2 achieves a ratio of a total track length to a diagonal length of an effective image area of the image sensor of 0.62, and a F number of 1.80. As shown in Table 10, the imaging lens in Example 2 satisfies the conditional expressions (1) to (25).

FIG. 4 shows spherical aberration (mm), astigmatism (mm), and distortion (%) of the imaging lens in Example 2. As shown in FIG. 4, each aberration is corrected excellently.

### Example 3

The basic lens data is shown below in Table 3.

TABLE 3
Example 3
Unit mm
f = 5.71
Fno = 1.80
ω(°) = 41.8
ih = 5.16
TTL = 6.63
Surface Data

| i | r | d | Nd | υd |
|---|---|---|---|---|
| (Object) | Infinity | Infinity | | |
| 1 (Stop) | Infinity | −0.6462 | | |
| 2* | 2.0743 | 0.9213 | 1.535 | 55.69 (υd1) |
| 3* | 8.9478 | 0.0990 | | |
| 4* | 22.7236 | 0.3020 | 1.671 | 19.24 (υd2) |
| 5* | 6.7132 | 0.4281 | | |
| 6* | 30.9704 | 0.3467 | 1.671 | 19.24 (υd3) |
| 7* | 53.4872 | 0.2894 | | |
| 8* | −6.5987 | 0.7047 | 1.535 | 55.69 (υd4) |
| 9* | −3.6867 | 0.5203 | | |
| 10* | Infinity | 0.5233 | 1.671 | 19.24 (υd5) |
| 11* | Infinity | 0.2951 | | |
| 12* | 4.3979 | 0.8894 | 1.535 | 55.69 (υd6) |
| 13* | 1.9274 | 0.5000 | | |
| 14 | Infinity | 0.2100 | 1.517 | 64.20 |
| 15 | Infinity | 0.6700 | | |
| Image Plane | | | | |

Constituent Lens Data

| | | | TTL to diagonal length of |
|---|---|---|---|
| Lens | Start Surface | Focal Length | effective image area |
| 1 | 2 | 4.824 | 0.64 |
| 2 | 4 | 14.314 | |
| 3 | 6 | 109.008 | |
| 4 | 8 | 14.406 | |
| 5 | 10 | Infinity | |
| 6 | 12 | −7.336 | |

Aspheric Surface Data

| | 2nd Surface | 3rd Surface | 4th Surface | 5th Surface | 6th Surface | 7th Surface |
|---|---|---|---|---|---|---|
| k | −1.278528E−02 | 0.000000E+00 | 0.000000E+00 | 0.000000E+00 | 0.000000E+00 | 0.000000E+00 |
| A4 | −5.255526E−04 | −1.188243E−03 | 3.378898E−03 | 2.220309E−02 | −1.937979E−02 | −1.749506E−02 |
| A6 | 3.809762E−03 | −2.704297E−02 | −9.650916E−03 | −3.168629E−02 | −8.981195E−02 | −3.152494E−02 |
| A8 | −2.335007E−03 | 3.636568E−02 | −1.522861E−02 | 4.236369E−02 | 1.351388E−01 | −2.011471E−02 |
| A10 | 4.001374E−04 | −2.325977E−02 | 1.052371E−01 | 6.854909E−02 | −9.190943E−02 | 1.056323E−01 |
| A12 | 2.913275E−04 | 7.558040E−03 | −1.741961E−01 | −2.689244E−01 | −8.180158E−02 | −1.586461E−01 |
| A14 | −1.173445E−04 | −1.369542E−03 | 1.487232E−01 | 3.615566E−01 | 2.108260E−01 | 1.283965E−01 |
| A16 | 2.076960E−06 | 1.698074E−04 | −7.179074E−02 | −2.544671E−01 | −1.753378E−01 | −5.863026E−02 |
| A18 | −4.627949E−06 | 2.400305E−05 | 1.870062E−02 | 9.364817E−02 | 6.980175E−02 | 1.425374E−02 |
| A20 | 2.297770E−07 | −1.408141E−05 | −2.043763E−03 | −1.424458E−02 | −1.118127E−02 | −1.407224E−03 |
| | 8th Surface | 9th Surface | 10th Surface | 11th Surface | 12th Surface | 13th Surface |
| k | 0.000000E+00 | −7.279217E+00 | 0.000000E+00 | 0.000000E00 | 0.000000E+00 | −6.292118E+00 |
| A4 | 3.881548E−02 | 4.145479E−02 | 1.182631E−01 | 1.095340E−01 | −9.654698E−02 | −4.596010E−02 |
| A6 | −1.173617E−01 | −1.223399E−01 | −1.247951E−01 | −9.720831E−02 | 1.513969E−02 | 1.119971E−02 |
| A8 | 1.779517E−01 | 1.358458E−01 | 6.612464E−02 | 4.454035E−02 | −4.420945E−04 | −2.497485E−03 |
| A10 | −1.851964E−01 | −9.862175E−02 | −2.385286E−02 | −1.397224E−02 | −8.947694E−05 | 4.488762E−04 |
| A12 | 1.290646E−01 | 4.839278E−02 | 5.447998E−03 | 3.020855E−03 | 1.821407E−06 | −5.542244E−05 |
| A14 | −5.592968E−02 | −1.503380E−02 | −6.759299E−04 | −4.385495E−04 | 1.447743E−06 | 4.350211E−06 |
| A16 | 1.436340E−02 | 2.795100E−03 | 2.080867E−05 | 4.073072E−05 | −1.638168E−07 | −2.058589E−07 |
| A18 | −2.003765E−03 | −2.835400E−04 | 4.299968E−06 | −2.184464E−06 | 7.270949E−09 | 5.345221E−09 |
| A20 | 1.171830E−04 | 1.208174E−05 | −3.560637E−07 | 5.139802E−08 | −1.209662E−10 | −5.852184E−11 |

The imaging lens in Example 3 achieves a ratio of a total track length to a diagonal length of an effective image area of the image sensor of 0.64, and a F number of 1.80. As shown in Table 10, the imaging lens in Example 3 satisfies the conditional expressions (1) to (25).

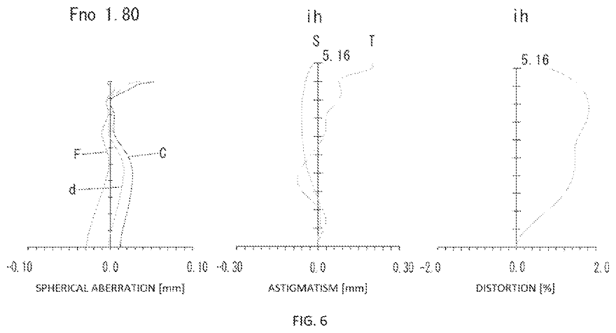

FIG. 6 shows spherical aberration (mm), astigmatism (mm), and distortion (%) of the imaging lens in Example 3. As shown in FIG. 6, each aberration is corrected excellently.

### Example 4

The basic lens data is shown below in Table 4.

TABLE 4
Example 4
Unit mm
f = 6.14
Fno = 1.80
ω(°) = 39.6
ih = 5.16
TTL = 6.63
Surface Data

| i | r | d | Nd | υd |
|---|---|---|---|---|
| (Object) | Infinity | Infinity | | |
| 1 (Stop) | Infinity | −0.8687 | | |
| 2* | 1.9676 | 1.0890 | 1.535 | 55.69 (υd1) |
| 3* | 8.3986 | 0.0786 | | |
| 4* | 28.3656 | 0.3020 | 1.671 | 19.24 (υd2) |
| 5* | 6.0780 | 0.4291 | | |
| 6* | 20.7511 | 0.3776 | 1.671 | 19.24 (υd3) |
| 7* | 25.4314 | 0.2868 | | |
| 8* | −8.6789 | 0.6396 | 1.535 | 55.69 (υd4) |
| 9* | −4.8530 | 0.6645 | | |
| 10* | Inifinity | 0.5100 | 1.671 | 19.24 (υd5) |
| 11* | Infinity | 0.3803 | | |
| 12* | 4.9163 | 0.6123 | 1.535 | 55.69 (υd6) |
| 13* | 2.0382 | 0.5000 | | |
| 14 | Infinity | 0.2100 | 1.517 | 64.20 |
| 15 | Infinity | 0.6192 | | |
| Image Plane | | | | |

Constituent Lens Data

| | | | TTL to diagonal length of |
|---|---|---|---|
| Lens | Start Surface | Focal Length | effective image area |
| 1 | 2 | 4.537 | 0.64 |
| 2 | 4 | −11.596 | |
| 3 | 6 | 162.832 | |
| 4 | 8 | 19.451 | |
| 5 | 10 | Infinity | |
| 6 | 12 | −7.032 | |

Aspheric Surface Data

| | 2nd Surface | 3rd Surface | 4th Surface | 5th Surface | 6th Surface | 7th Surface |
|---|---|---|---|---|---|---|
| k | −9.119539E−02 | 0.000000E+00 | 0.000000E+00 | 0.000000E+00 | 0.000000E+00 | 0.000000E+00 |
| A4 | −3.246516E−04 | −5.241096E−03 | −5.327097E−03 | 2.229596E−02 | −1.427563E−03 | −2.127970E−02 |
| A6 | 4.212351E−03 | −2.112078E−02 | 3.590785E−02 | 3.629311E−02 | −2.549357E−01 | −7.410389E−02 |
| A8 | −2.216849E−03 | 3.017545E−02 | −8.672689E−02 | −2.382956E−01 | 8.717563E−01 | 1.559203E−01 |
| A10 | 3.299079E−04 | −1.771378E−02 | 1.4136960E−01 | 8.104086E+00 | −1.969089E+00 | −2.600505E−01 |
| A12 | 2.775639E−04 | 5.347337E−03 | −1.297972E−01 | −1.488139E+00 | 2.86558E+00 | 2.920801E−01 |
| A14 | −6.688075E−05 | −9.065868E−04 | 6.980230E−02 | 1.612053E+00 | −2.663388E+00 | −2.106324E−01 |
| A16 | −6.668225E−06 | 1.003296E−04 | −2.165680E−02 | −1.028936E+00 | 1.518369E+00 | 9.399640E−02 |
| A18 | −1.744694E−06 | 1.141781E−05 | 3.567999E−03 | 3.583631E−01 | −4.812410E−01 | −2.330843E−02 |
| A20 | 6.802068E−08 | −5.703994E−06 | −2.318285E−04 | −5.252471E−02 | 6.459400E−02 | 2.412839E−03 |
| | 8th Surface | 9th Surface | 10th Surface | 11th Surface | 12th Surface | 13th Surface |
| k | 0.000000E+00 | −3.647129E+00 | 0.000000E+00 | 0.000000E+00 | 0.000000E+00 | −5.452034E+00 |
| A4 | 1.535004E−02 | 5.288736E−03 | 2.807722E−02 | 3.616938E−02 | −1.228809E−01 | −7.902409E−02 |
| A6 | −8.271341E−02 | −2.803100E−02 | −3.642242E−02 | −4.570169E−02 | 2.713899E−02 | 2.636616E−02 |
| A8 | 1.337923E−01 | 2.991981E−02 | 6.525183E−03 | 2.153685E−02 | −2.776956E−03 | −7.079183E−03 |
| A10 | −1.538981E−01 | −2.298935E−02 | 4.414141E−03 | −6.741831E−03 | 1.146786E−04 | 1.416059E−03 |
| A12 | 1.126074E−01 | 1.282007E−02 | −3.702691E−03 | 1.353158E−03 | 3.473847E−06 | −1.921997E−04 |
| A14 | −4.832207E−02 | −4.318645E−03 | 1.213860E−03 | −1.636382E−04 | −6.302567E−07 | 1.672613E−05 |
| A16 | 1.185067E−02 | 8.244144E−04 | −2.041687E−04 | 1.121318E−05 | 2.902102E−08 | −8.870609E−07 |
| A18 | −1.544430E−03 | −8.255373E−05 | 1.736401E−05 | −3.879225E−07 | −5.031836E−10 | 2.605273E−08 |
| A20 | 8.313196E−05 | 3.376179E−06 | −5.926596E−07 | 5.003655E−09 | −1.522000E−25 | −3.246034E−10 |

The imaging lens in Example 4 achieves a ratio of a total track length to a diagonal length of an effective image area of the image sensor of 0.64, and a F number of 1.80. As shown in Table 10, the imaging lens in Example 4 satisfies the conditional expressions (1) to (25).

FIG. 8 shows spherical aberration (mm), astigmatism (mm), and distortion (%) of the imaging lens in Example 4. As shown in FIG. 8, each aberration is corrected excellently.

### Example 5

The basic lens data is shown below in Table 5.

TABLE 5
Example 5
Unit mm
f = 6.14
Fno = 1.90
ω(°) = 39.8
ih = 5.16
TTL = 6.63
Surface Data

| i | r | d | Nd | υd |
|---|---|---|---|---|
| (Object) | Infinity | Infinity | | |
| 1 (Stop) | Infinity | −0.7871 | | |
| 2* | 1.9722 | 0.9945 | 1.535 | 55.69 (υd1) |
| 3* | 8.6690 | 0.1255 | | |
| 4* | 18.6363 | 0.3020 | 1.671 | 19.24 (υd2) |
| 5* | 5.2172 | 0.4017 | | |
| 6* | 30.6380 | 0.3400 | 1.671 | 19.24 (υd3) |
| 7* | 39.5489 | 0.3410 | | |
| 8* | −13.1064 | 0.4441 | 1.535 | 55.69 (υd4) |
| 9* | −6.8684 | 0.7418 | | |
| 10* | Infinity | 0.5087 | 1.671 | 19.24 (υd5) |
| 11* | Infinity | 0.2160 | | |
| 12* | 4.3746 | 0.8655 | 1.535 | 55.69 (υd6) |
| 13* | 2.1506 | 0.5000 | | |
| 14 | Infinity | 0.2100 | 1.517 | 64.20 |
| 15 | Infinity | 0.7085 | | |
| Image Plane | | | | |

Constituent Lens Data

| | | | TTL to diagonal length of |
|---|---|---|---|
| Lens | Start Surface | Focal Length | effective image area |
| 1 | 2 | 4.539 | 0.64 |
| 2 | 4 | −10.901 | |
| 3 | 6 | 199.901 | |
| 4 | 8 | 26.330 | |
| 5 | 10 | Infinity | |
| 6 | 12 | −9.151 | |

Aspheric Surface Data

| | 2nd Surface | 3rd Surface | 4th Surface | 5th Surface | 6th Surface | 7th Surface |
|---|---|---|---|---|---|---|
| k | −1.007005E−01 | 0.000000E+00 | 0.000000E+00 | 0.000000E+00 | 0.000000E+00 | 0.000000E+00 |
| A4 | 1.775843E−03 | −7.896413E−04 | 4.221137E−03 | 2.343879E−03 | −5.325609E−02 | −3.074185E−02 |
| A6 | 2.706551E−03 | −1.364469E−02 | −1.966786E−02 | 9.489537E−02 | 9.029797E−02 | −4.867383E−02 |
| A8 | −1.227047E−03 | 2.086437E−02 | 6.640442E−02 | −3.846541E−01 | −4.527013E−01 | 1.180542E−01 |
| A10 | 4.149291E−04 | −1.241310E−02 | −1.006000E−01 | 1.023297E+00 | 1.225669E+00 | −1.910293E−01 |
| A12 | 1.478170E−04 | 3.530422E−03 | 1.083350E−01 | −1.644898E+00 | −1.988307E+00 | 2.099283E−01 |
| A14 | −4.898095E−05 | −5.195469E−04 | −8.063029E−02 | 1.643852E+00 | 1.984414E+00 | −1.502033E−01 |
| A16 | −9.420606E−06 | 8.765072E−05 | 3.800807E−02 | −9.989531E−01 | −1.195326E+00 | 6.778050E−02 |
| A18 | 2.197544E−06 | 4.923187E−06 | −9.977754E−03 | 3.383568E−01 | 3.995551E−01 | −1.737440E−02 |
| A20 | 6.857834E−07 | −7.533125E−06 | 1.102820E−03 | −4.888751E−02 | −5.704334E−02 | 1.908438E−03 |
| | 8th Surface | 9th Surface | 10th Surface | 11th Surface | 12th Surface | 13th Surface |
| k | 0.000000E+00 | 1.671910E+00 | 0.000000E+00 | 0.000000E+00 | 0.000000E+00 | −5.183916E+00 |
| A4 | 3.507865E−03 | 7.548975E−03 | 5.687186E−02 | 3.958860E−02 | −1.297070E−01 | −7.403091E−02 |
| A6 | −1.066785E−01 | −7.043116E−02 | −5.296237E−02 | −3.896061E−02 | 3.131945E−02 | 2.602552E−02 |
| A8 | 1.720528E−01 | 8.612461E−02 | 1.467566E−02 | 1.657545E−02 | −4.564853E−03 | −7.557025E−03 |
| A10 | −1.817591E−01 | −7.024566E−02 | 2.156711E−03 | −5.320930E−03 | 5.801799E−04 | 1.572039E−03 |
| A12 | 1.249694E−01 | 3.832291E−02 | −3.994697E−03 | 1.176408E−03 | −7.273919E−05 | −2.147937E−04 |
| A14 | −5.174621E−02 | −1.264256E−02 | 1.599620E−03 | −1.772592E−04 | 7.170265E−06 | 1.853072E−05 |
| A16 | 1.238983E−02 | 2.400691E−03 | −3.182940E−04 | 1.858281E−05 | −4.521968E−07 | −9.697529E−07 |
| A18 | −1.582545E−03 | −2.418713E−04 | 3.260362E−05 | −1.255203E−06 | 1.581284E−08 | 2.812892E−08 |
| A20 | 8.335517E−05 | 1.002462E−05 | −1.369951E−06 | 3.979265E−08 | −2.333496E−10 | −3.474091E−10 |

The imaging lens in Example 5 achieves a ratio of a total track length to a diagonal length of an effective image area of the image sensor of 0.64, and a F number of 1.90. As shown in Table 10, the imaging lens in Example 5 satisfies the conditional expressions (1) to (25).

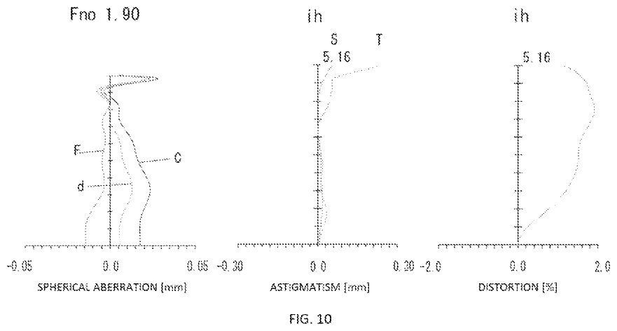

FIG. 10 shows spherical aberration (mm), astigmatism (mm), and distortion (%) of the imaging lens in Example 5. As shown in FIG. 10, each aberration is corrected excellently.

### Example 6

The basic lens data is shown below in Table 6.

TABLE 6
Example 6
Unit mm
f = 5.57
Fno = 1.80
ω(°) = 42.5
ih = 5.16
TTL = 6.43
Surface Data

| i | r | d | Nd | υd |
|---|---|---|---|---|
| (Object) | Infinity | Infinity | | |
| 1 (Stop) | Infinity | −0.6186 | | |
| 2* | 2.0611 | 0.9090 | 1.535 | 55.69 (υd1) |
| 3* | 10.2395 | 0.0800 | | |
| 4* | 24.6018 | 0.3054 | 1.671 | 19.24 (υd2) |
| 5* | 6.6621 | 0.4238 | | |
| 6* | −1481.3690 | 0.3469 | 1.671 | 19.24 (υd3) |
| 7* | −710.5321 | 0.3578 | | |
| 8* | −5.2771 | 0.5942 | 1.535 | 55.69 (υd4) |
| 9* | −2.8884 | 0.4213 | | |
| 10* | 22.3476 | 0.4540 | 1.671 | 19.24 (υd5) |
| 11* | 15.9948 | 0.5312 | | |
| 12* | 4.5997 | 0.7985 | 1.535 | 55.69 (υd6) |
| 13* | 1.8569 | 0.2496 | | |
| 14 | Infinity | 0.2100 | 1.517 | 64.20 |
| 15 | Infinity | 0.8181 | | |
| Image Plane | | | | |

Constituent Lens Data

| | | | TTL to diagonal length of |
|---|---|---|---|
| Lens | Start Surface | Focal Length | effective image area |
| 1 | 2 | 4.645 | 0.62 |
| 2 | 4 | −13.715 | |
| 3 | 6 | 2035.394 | |
| 4 | 8 | 10.980 | |
| 5 | 10 | −86.363 | |
| 6 | 12 | −6.480 | |

Aspheric Surface Data

| | 2nd Surface | 3rd Surface | 4th Surface | 5th Surface | 6th Surface | 7th Surface |
|---|---|---|---|---|---|---|
| k | −2.995385E−02 | 0.000000E+00 | 0.000000E+00 | 0.000000E+00 | 0.000000E+00 | 0.000000E+00 |
| A4 | 9.982493E−05 | −2.794461E−03 | −1.425110E−02 | 3.191536E−02 | −1.480382E−02 | −2.790903E−02 |
| A6 | 3.269383E−03 | −2.840156E−02 | 6.968651E−02 | −1.417807E−01 | −2.301230E−01 | −7.281587E−03 |
| A8 | −2.172245E−03 | 3.693613E−02 | −2.237157E−01 | 5.095011E−01 | 7.412691E−01 | −1.103191E−01 |
| A10 | 3.661854E−04 | −2.306480E−02 | 4.260043E−01 | −1.045072E+00 | −1.590810E+00 | 3.108812E−01 |
| A12 | 3.000616E−04 | 7.765677E−03 | −4.770074E−01 | 1.325804E+00 | 2.196771E+00 | −4.302556E−01 |
| A14 | −1.528057E−04 | −1.429789E−03 | 3.288589E−01 | −1.043284E+00 | −1.948780E+00 | 3.474856E−01 |
| A16 | 3.895957E−06 | 1.273815E−04 | −1.376091E−01 | 4.863595E−01 | 1.068609E+00 | −1.647422E−01 |
| A18 | −3.444996E−06 | 1.048013E−05 | 3.215980E−02 | −1.209981E−01 | −3.284850E−01 | 4.248573E−02 |
| A20 | −5.910845E−07 | −5.000520E−06 | −3.216470E−03 | 1.190932E−02 | 4.301090E−02 | −4.575111E−03 |
| | 8th Surface | 9th Surface | 10th Surface | 11th Surface | 12th Surface | 13th Surface |
| k | 0.000000E+00 | −6.650208E+00 | 0.000000E+00 | 0.000000E+00 | 0.000000E+00 | −6.376127E+00 |
| A4 | 5.649203E−02 | 7.998330E−02 | 1.822030E−01 | 1.374945E−01 | −1.156077E−01 | −5.530898E−02 |
| A6 | −1.364588E−01 | −1.870982E−01 | −2.225908E−01 | −1.332427E−01 | 3.281308E−02 | 1.595767E−02 |
| A8 | 1.737642E−01 | 1.804454E−01 | 1.458130E−01 | 6.465596E−02 | −8.091120E−03 | −4.346142E−03 |
| A10 | −1.548349E−01 | −1.143874E−01 | −6.739446E−02 | −2.117263E−02 | 1.635038E−03 | 9.084828E−04 |
| A12 | 9.727553E−02 | 5.095019E−02 | 2.154687E−02 | 4.793346E−03 | −2.234411E−04 | −1.279839E−04 |
| A14 | −3.937109E−02 | −1.490027E−02 | −4.529357E−03 | −7.286852E−04 | 1.929012E−05 | 1.142018E−05 |
| A16 | 9.538870E−03 | 2.648535E−03 | 5.858811E−04 | 7.002357E−05 | −1.011381E−06 | −6.137839E−07 |
| A18 | −1.250916E−03 | −2.572377E−04 | −4.183781E−05 | −3.806856E−06 | 2.949815E−08 | 1.809412E−08 |
| A20 | 6.812314E−05 | 1.043866E−05 | 1.256839E−06 | 8.874153E−08 | −3.681262E−10 | −2.247148E−10 |

The imaging lens in Example 6 achieves a ratio of a total track length to a diagonal length of an effective image area of the image sensor of 0.62, and a F number of 1.80. As shown in Table 10, the imaging lens in Example 6 satisfies the conditional expressions (1) to (25).

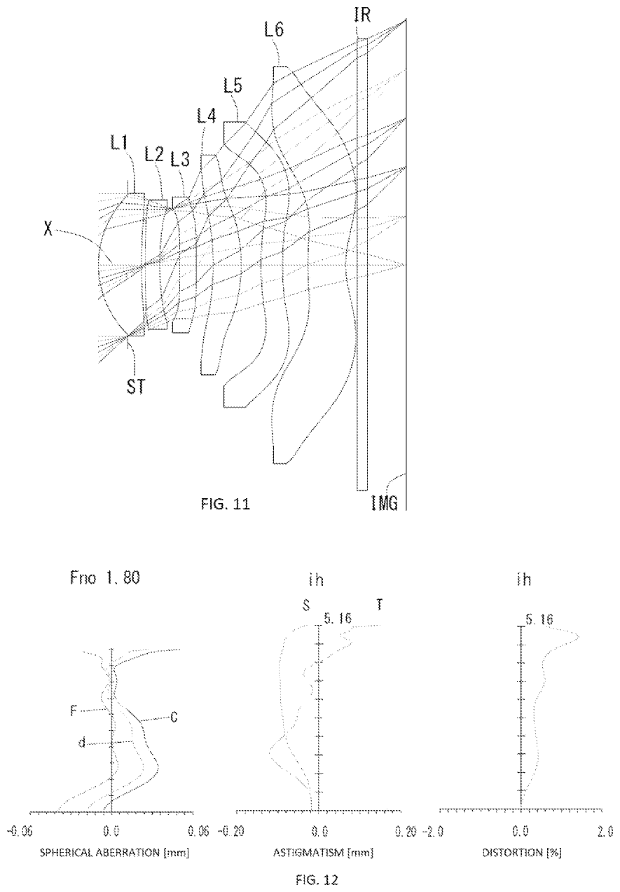

FIG. 12 shows spherical aberration (mm), astigmatism (mm), and distortion (%) of the imaging lens in Example 6. As shown in FIG. 12, each aberration is corrected excellently.

### Example 7

The basic lens data is shown below in Table 7.

TABLE 7
Example 7
Unit mm
f = 5.58
Fno = 1.90
ω(°) = 42.5
ih = 5.16
TTL = 6.43
Surface Data

| i | r | d | Nd | υd |
|---|---|---|---|---|
| (Object) | Infinity | Infinity | | |
| 1 (Stop) | Infinity | −0.5240 | | |
| 2* | 2.0637 | 0.8295 | 1.535 | 55.69 (υd1) |
| 3* | 8.2090 | 0.1254 | | |
| 4* | 21.8680 | 0.3054 | 1.671 | 19.24 (υd2) |
| 5* | 6.9947 | 0.3875 | | |
| 6* | −64.9934 | 0.3469 | 1.671 | 19.24 (υd3) |
| 7* | −67.5477 | 0.2903 | | |
| 8* | −8.3418 | 0.5483 | 1.535 | 55.69 (υd4) |
| 9* | −5.6360 | 0.5111 | | |
| 10* | 3.5112 | 0.5218 | 1.614 | 25.59 (υd5) |
| 11* | 4.5068 | 0.6728 | | |
| 12* | 5.2436 | 0.7718 | 1.535 | 55.69 (υd6) |
| 13* | 1.9664 | 0.2364 | | |
| 14 | Infinity | 0.2100 | 1.517 | 64.20 |
| 15 | Infinity | 0.7432 | | |
| Image Plane | | | | |

Constituent Lens Data

| | | | TTL to diagonal length of |
|---|---|---|---|
| Lens | Start Surface | Focal Length | effective image area |
| 1 | 2 | 4.923 | 0.62 |
| 2 | 4 | −15.460 | |
| 3 | 6 | −2710.102 | |
| 4 | 8 | 30.347 | |
| 5 | 10 | 21.574 | |
| 6 | 12 | −6.409 | |

Aspheric Surface Data

| | 2nd Surface | 3rd Surface | 4th Surface | 5th Surface | 6th Surface | 7th Surface |
|---|---|---|---|---|---|---|
| k | 4.368542E−02 | 0.000000E+00 | 0.000000E+00 | 0.000000E+00 | 0.000000E+00 | 0.000000E+00 |
| A4 | −5.935464E−04 | −1.344978E−02 | −4.130650E−02 | 4.680501E−03 | −3.101310E−02 | −4.531729E−02 |
| A6 | 2.720424E−03 | −1.835702E−02 | 1.245645E−01 | −7.293486E−02 | −1.576906E−01 | 4.553697E−02 |
| A8 | −2.045638E−03 | 3.305268E−02 | −3.614765E−01 | 3.567307E−01 | 5.319672E−01 | −1.773042E−01 |
| A10 | 4.063944E−04 | −2.416202E−02 | 7.216592E−01 | −8.657168E−01 | −1.163207E+00 | 3.649014E−01 |
| A12 | 2.930869E−04 | 8.430422E−03 | −8.896298E−01 | 1.313641E+00 | 1.586254E+00 | −4.514061E−01 |
| A14 | −1.928941E−04 | −1.421558E−03 | 6.812945E−01 | −1.264166E+00 | −1.369875E+00 | 3.446327E−01 |
| A16 | 3.870821E−06 | 1.274068E−04 | −3.164321E−01 | 7.437289E−01 | 7.239988E−01 | −1.582362E−01 |
| A18 | −3.444996E−06 | 1.048013E−05 | 8.176894E−02 | −2.429871E−01 | −2.126678E−01 | 4.009491E−02 |
| A20 | −5.910845E−07 | −5.000520E−06 | −9.006320E−03 | 3.360639E−02 | 2.640873E−02 | −4.282505E−03 |
| | 8th Surface | 9th Surface | 10th Surface | 11th Surface | 12th Surface | 13th Surface |
| k | 0.000000E+00 | −5.421141E+00 | 0.000000E+00 | 0.000000E+00 | 0.000000E+00 | −7.304665E+00 |
| A4 | −5.006792E−03 | −2.535535E−02 | −3.510737E−04 | 7.112392E−03 | −1.364316E−01 | −5.355243E−02 |
| A6 | −2.940313E−02 | −4.080099E−02 | −4.301438E−02 | −2.119890E−02 | 4.915352E−02 | 1.496415E−02 |
| A8 | 5.364173E−02 | 6.927113E−02 | 3.203938E−02 | 9.451601E−03 | −1.381128E−02 | −3.066764E−03 |
| A10 | −4.561151E−02 | −5.744732E−02 | −1.697076E−02 | −3.498699E−03 | 2.805055E−03 | 3.515880E−04 |
| A12 | 2.725884E−02 | 3.100927E−02 | 5.835001E−03 | 9.674238E−04 | −3.728775E−04 | −1.431524E−05 |
| A14 | −1.081273E−02 | −1.029116E−02 | −1.250175E−03 | −1.791307E−04 | 3.136238E−05 | −1.039458E−06 |
| A16 | 2.581135E−03 | 1.989939E−03 | 1.573134E−04 | 2.043362E−05 | −1.609884E−06 | 1.442084E−07 |
| A18 | −3.320583E−04 | −2.054510E−04 | −1.033646E−05 | −1.281141E−06 | 4.607272E−08 | −6.082926E−09 |
| A20 | 1.765088E−05 | 8.757263E−06 | 2.626780E−07 | 3.359175E−08 | −5.638166E−10 | 9.123208E−11 |

The imaging lens in Example 7 achieves a ratio of a total track length to a diagonal length of an effective image area of the image sensor of 0.62, and a F number of 1.90. As shown in Table 10, the imaging lens in Example 7 satisfies the conditional expressions (1) to (25).

FIG. 14 shows spherical aberration (mm), astigmatism (mm), and distortion (%) of the imaging lens in Example 7. As shown in FIG. 14, each aberration is corrected excellently.

### Example 8

The basic lens data is shown below in Table 8.

TABLE 8
Example 8
Unit mm
f = 5.55
Fno = 1.90
ω(°) = 42.5
ih = 5.16
TTL = 6.43
Surface Data

| i | r | d | Nd | υd |
|---|---|---|---|---|
| (Object) | Infinity | Infinity | | |
| 1 (Stop) | Infinity | −0.5162 | | |
| 2* | 2.0703 | 0.8088 | 1.535 | 55.69 (υd1) |
| 3* | 7.7273 | 0.1206 | | |
| 4* | 22.4571 | 0.3020 | 1.671 | 19.24 (υd2) |
| 5* | 6.9633 | 0.3786 | | |
| 6* | 36.9031 | 0.3498 | 1.671 | 19.24 (υd3) |
| 7* | 32.1074 | 0.2569 | | |
| 8* | −7.3241 | 0.6015 | 1.535 | 55.69 (υd4) |
| 9* | −4.4329 | 0.6052 | | |
| 10* | 3.0741 | 0.4854 | 1.614 | 25.59 (υd5) |
| 11* | 3.7036 | 0.7219 | | |
| 12* | 5.8369 | 0.6581 | 1.535 | 55.69 (υd6) |
| 13* | 2.0485 | 0.2364 | | |
| 14 | Infinity | 0.2100 | 1.517 | 64.20 |
| 15 | Infinity | 0.7646 | | |
| Image Plane | | | | |

Constituent Lens Data

| | | | TTL to diagonal length of |
|---|---|---|---|
| Lens | Start Surface | Focal Length | effective image area |
| 1 | 2 | 5.037 | 0.62 |
| 2 | 4 | −15.166 | |
| 3 | 6 | −379.461 | |
| 4 | 8 | 19.578 | |
| 5 | 10 | 22.768 | |
| 6 | 12 | −6.282 | |

Aspheric Surface Data

| | 2nd Surface | 3rd Surface | 4th Surface | 5th Surface | 6th Surface | 7th Surface |
|---|---|---|---|---|---|---|
| k | 1.087319E−01 | 0.000000E+00 | 0.000000E+00 | 0.000000E+00 | 0.000000E+00 | 0.000000E+00 |
| A4 | −1.884312E−03 | −1.761737E−02 | −4.117689E−02 | −6.878791E−03 | −6.726185E−02 | −6.625548E−02 |
| A6 | 2.634591E−03 | −1.222730E−02 | 1.198967E−01 | −8.235104E−03 | 1.223731E−02 | 9.666322E−02 |
| A8 | −2.377288E−03 | 3.097228E−02 | −3.237535E−01 | 1.456923E−01 | −5.518588E−02 | −3.076636E−01 |
| A10 | 5.438952E−04 | −2.418928E−02 | 6.487083E−01 | −4.045971E−01 | 9.173587E−02 | 5.859121E−01 |
| A12 | 2.747516E−04 | 8.534195E−03 | −8.096764E−01 | 6.615451E−01 | −1.240093E−01 | −6.911205E−01 |
| A14 | −2.085279E−04 | −1.421558E−03 | 6.255059E−01 | −6.763811E−01 | 1.188663E−01 | 5.087380E−01 |
| A16 | 3.870821E−06 | 1.274068E−04 | −2.918556E−01 | 4.173718E−01 | −7.892419E−02 | −2.267138E−01 |
| A18 | −3.444996E−06 | 1.048013E−05 | 7.553753E−02 | −1.413429E−01 | 3.172722E−02 | 5.593954E−02 |
| A20 | −5.910845E−07 | −5.000520E−06 | −8.308731E−03 | 2.007469E−02 | −5.577384E−03 | −5.783385E−03 |
| | 8th Surface | 9th Surface | 10th Surface | 11th Surface | 12th Surface | 13th Surface |
| k | 0.000000E+00 | −3.533944E+00 | 0.000000E+00 | 0.000000E+00 | 0.000000E+00 | −8.252988E+00 |
| A4 | −2.349238E−02 | −4.330376E−02 | −2.188987E−02 | −2.344462E−03 | −1.335880E−01 | −5.304168E−02 |
| A6 | −1.115980E−03 | −1.606832E−02 | −2.968316E−02 | −2.720078E−02 | 4.673623E−02 | 1.321618E−02 |
| A8 | 2.204969E−02 | 5.229911E−02 | 2.123073E−02 | 1.517784E−02 | −1.318087E−02 | −2.236353E−03 |
| A10 | −1.897137E−02 | −5.278109E−02 | −9.541653E−03 | −5.596207E−03 | 2.751552E−03 | 1.490802E−04 |
| A12 | 1.453893E−02 | 3.295637E−02 | 2.653665E−03 | 1.388792E−03 | −3.761396E−04 | 1.709271E−05 |
| A14 | −7.842896E−03 | −1.213821E−02 | −4.332186E−04 | −2.275364E−04 | 3.241792E−05 | −4.201909E−06 |
| A16 | 2.376362E−03 | 2.537104E−03 | 3.487630E−05 | 2.336915E−06 | −1.700825E−06 | 3.406377E−07 |
| A18 | −3.654017E−04 | −2.788877E−04 | −5.391603E−07 | −1.348515E−06 | 4.968334E−08 | −1.282274E−08 |
| A20 | 2.232780E−05 | 1.253338E−05 | −5.804903E−08 | 3.311868E−08 | −6.201384E−10 | 1.882187E−10 |

The imaging lens in Example 8 achieves a ratio of a total track length to a diagonal length of an effective image area of the image sensor of 0.62, and a F number of 1.90. As shown in Table 10, the imaging lens in Example 8 satisfies the conditional expressions (1) to (25).

FIG. 16 shows spherical aberration (mm), astigmatism (mm), and distortion (%) of the imaging lens in Example 8. As shown in FIG. 16, each aberration is corrected excellently.

### Example 9

The basic lens data is shown below in Table 9.

TABLE 9
Example 9
Unit mm
f = 6.31
Fno = 1.90
ω(°) = 39.0
ih = 5.16
TTL = 6.75
Surface Data

| i | r | d | Nd | υd |
|---|---|---|---|---|
| (Object) | Infinity | Infinity | | |
| 1 (Stop) | Infinity | −0.7850 | | |
| 2* | 1.9800 | 0.9909 | 1.535 | 55.69 (υd1) |
| 3* | 9.0444 | 0.1189 | | |
| 4* | 20.9090 | 0.3036 | 1.671 | 19.24 (υd2) |
| 5* | 4.9534 | 0.4115 | | |
| 6* | 25.5481 | 0.4350 | 1.671 | 19.24 (υd3) |
| 7* | 40.1816 | 0.3884 | | |
| 8* | −13.7121 | 0.4436 | 1.535 | 55.69 (υd4) |
| 9* | −6.2530 | 0.7624 | | |
| 10* | −100.0000 | 0.5727 | 1.535 | 55.69 (υd5) |
| 11* | −150.0000 | 0.2500 | | |
| 12* | 4.6311 | 0.7737 | 1.535 | 55.69 (υd6) |
| 13* | 2.0665 | 0.5000 | | |
| 14 | Infinity | 0.2100 | 1.517 | 64.20 |
| 15 | Infinity | 0.6592 | | |
| Image Plane | | | | |

Constituent Lens Data

| | | | TTL to diagonal length of |
|---|---|---|---|
| Lens | Start Surface | Focal Length | effective image area |
| 1 | 2 | 4.519 | 0.65 |
| 2 | 4 | −9.752 | |
| 3 | 6 | 103.354 | |
| 4 | 8 | 21.057 | |
| 5 | 10 | −563.194 | |
| 6 | 12 | −7.797 | |

Aspheric Surface Data

| | 2nd Surface | 3rd Surface | 4th Surface | 5th Surface | 6th Surface | 7th Surface |
|---|---|---|---|---|---|---|
| k | −9.674924E−02 | 2.950749E−02 | 0.000000E+00 | 0.000000E+00 | 0.000000E+00 | 0.000000E+00 |
| A4 | 1.727784E−03 | −6.407794E−04 | 4.972681E−03 | 1.030332E−03 | −5.216387E−02 | −2.869472E−02 |
| A6 | 2.758579E−03 | −1.273481E−02 | −1.941405E−02 | 9.481656E−02 | 8.765351E−02 | −5.272072E−02 |
| A8 | −1.300525E−03 | 2.043361E−02 | 6.623969E−02 | −3.821596E−01 | −4.519023E−01 | 1.242249E−01 |
| A10 | 4.355959E−04 | −1.250426E−02 | −1.007258E−01 | 1.014822E+00 | 1.225777E+00 | −1.960032E−01 |
| A12 | 1.518879E−04 | 3.546289E−03 | 1.083491E−01 | −1.636229E+00 | −1.988716E+00 | 2.111569E−01 |
| A14 | −5.081599E−05 | −4.888028E−04 | −8.059222E−02 | 1.641164E+00 | 1.984218E+00 | −1.495140E−01 |
| A16 | −1.052762E−05 | 8.356581E−05 | 3.802918E−02 | −9.997913E−01 | −1.195217E+00 | 6.726311E−02 |
| A18 | 2.465326E−06 | 2.255431E−06 | −9.989306E−03 | 3.387978E−01 | 3.997001E−01 | −1.728808E−02 |
| A20 | 2.350110E−07 | −6.885872E−06 | 1.105322E−03 | −4.883433E−02 | −5.710615E−02 | 1.891100E−03 |
| | 8th Surface | 9th Surface | 10th Surface | 11th Surface | 12th Surface | 13th Surface |
| k | 0.000000E+00 | −2.875375E−02 | 0.000000E+00 | 0.000000E+00 | 0.000000E+00 | −5.750496E+00 |
| A4 | 4.614369E−03 | 1.115973E−02 | 5.454836E−02 | 3.906010E−02 | −1.288791E−01 | −7.385064E−02 |
| A6 | −1.071119E−01 | −7.154626E−02 | −5.238723E−02 | −3.843537E−02 | 3.095186E−02 | 2.607737E−02 |
| A8 | 1.722145E−01 | 8.648223E−02 | 1.495929E−02 | 1.661386E−02 | −4.488708E−03 | −7.559422E−03 |
| A10 | −1.817394E−01 | −7.031089E−02 | 1.895526E−03 | −5.338374E−03 | 5.743688E−04 | 1.571671E−03 |
| A12 | 1.249804E−01 | 3.832349E−02 | −3.877100E−03 | 1.178039E−03 | −7.322504E−05 | −2.147456E−04 |
| A14 | −5.174781E−02 | −1.264070E−02 | 1.579621E−03 | −1.772152E−04 | 7.294793E−06 | 1.853244E−05 |
| A16 | 1.238995E−02 | 2.400844E−03 | −3.189006E−04 | 1.856002E−05 | −4.605621E−07 | −9.701171E−07 |
| A18 | −1.582533E−03 | −2.419080E−04 | 3.313920E−05 | −1.255938E−06 | 1.596998E−08 | 2.813797E−08 |
| A20 | 8.351854E−05 | 1.002563E−05 | −1.409635E−06 | 4.016471E−08 | −2.312783E−10 | −3.475670E−10 |

The imaging lens in Example 9 achieves a ratio of a total track length to a diagonal length of an effective image area of the image sensor of 0.65, and a F number of 1.90. As shown in Table 10, the imaging lens in Example 9 satisfies the conditional expressions (1) to (25).

FIG. 18 shows spherical aberration (mm), astigmatism (mm), and distortion (%) of the imaging lens in Example 9. As shown in FIG. 18, each aberration is corrected excellently.

In table 10, values of conditional expressions (1) to (25) related to Examples 1 to 9 are shown.

TABLE 10

| Conditional Expression | | Example 1 | Example 2 | Example 3 | Example 4 | Example 5 |
|---|---|---|---|---|---|---|
| (1) | νd 3 | 19.24 | 19.24 | 19.24 | 19.24 | 19.24 |
| (2) | (r2/\|r6\|) × 100 | 0.77 | 32.09 | 16.73 | 33.02 | 21.92 |
| (3) | (\|r5/r6\|) × 100 | 2.79 | 110.03 | 57.90 | 81.60 | 77.47 |
| (4) | r11/(T4 + D5 + T5) | 4.07 | 3.16 | 3.29 | 3.16 | 2.98 |
| (5) | (r2/r4/\|r6\|) × 100 | 0.10 | 3.67 | 2.49 | 5.43 | 4.20 |
| (6) | r3/f2 | −2.88 | −3.16 | −1.59 | −2.45 | −1.71 |
| (7) | r3/(T2/T1) | 5.70 | 8.94 | 5.25 | 5.20 | 5.82 |
| (8) | νd 4 | 55.69 | 55.69 | 55.69 | 55.69 | 55.69 |
| (9) | f4/D4 | 14.36 | 13.99 | 20.44 | 30.41 | 59.29 |
| (10) | (f1/f4) × 100 | 37.03 | 41.85 | 33.48 | 23.32 | 17.24 |
| (11) | \|r6\|/r12 | 601.18 | 15.29 | 27.75 | 12.48 | 18.39 |
| (12) | r3/r4 | 5.30 | 5.73 | 3.38 | 4.67 | 3.57 |
| (13) | (r4/\|r6\|) × 100 | 0.69 | 32.37 | 12.55 | 23.90 | 13.19 |
| (14) | r8/r11 | −0.56 | −0.72 | −0.84 | −0.99 | −1.57 |
| (15) | r11/r12 | 2.81 | 2.59 | 2.28 | 2.41 | 2.03 |
| (16) | r3/f | 7.23 | 9.04 | 3.98 | 4.62 | 3.04 |
| (17) | r4/T2 | 16.40 | 19.51 | 15.68 | 14.16 | 12.99 |
| (18) | \|r5\|/f | 5.52 | 5.36 | 5.42 | 3.38 | 4.99 |
| (19) | \|r6\|/D3 | 2819.62 | 79.56 | 154.27 | 67.35 | 116.32 |
| (20) | r11/f | 0.92 | 0.83 | 0.77 | 0.80 | 0.71 |
| (21) | \|r6\|/r11 | 214.24 | 5.90 | 12.16 | 5.17 | 9.04 |
| (22) | \|r6\|/(T2 + D3) | 1291.40 | 34.29 | 69.03 | 31.52 | 53.32 |
| (23) | r12/r11 | 0.36 | 0.39 | 0.44 | 0.41 | 0.49 |
| (24) | r11/D6 | 8.37 | 6.88 | 4.94 | 8.03 | 5.05 |
| (25) | r4/(T2/T1) | 1.07 | 1.56 | 1.55 | 1.11 | 1.63 |

| Conditional Expression | | Example 6 | Example 7 | Example 8 | Example 9 |
|---|---|---|---|---|---|
| (1) | νd 3 | 19.24 | 19.24 | 19.24 | 19.24 |
| (2) | (r2/\|r6\|) × 100 | 1.44 | 12.15 | 24.07 | 22.51 |
| (3) | (\|r5/r6\|) × 100 | 208.49 | 96.22 | 114.94 | 63.58 |
| (4) | r11/(T4 + D5 + T5) | 3.27 | 3.07 | 3.22 | 2.92 |
| (5) | (r2/r4/\|r6\|) × 100 | 0.22 | 1.74 | 3.46 | 4.54 |
| (6) | r3/f2 | −1.79 | −1.41 | −1.48 | −2.14 |
| (7) | r3/(T2/T1) | 4.64 | 7.08 | 7.15 | 6.04 |
| (8) | νd 4 | 55.69 | 55.69 | 55.69 | 55.69 |
| (9) | f4/D4 | 18.48 | 55.34 | 32.55 | 47.47 |
| (10) | (f1/f4) × 100 | 42.31 | 16.22 | 25.73 | 21.46 |
| (11) | \|r6\|/r12 | 382.64 | 34.35 | 15.67 | 19.44 |
| (12) | r3/r4 | 3.69 | 3.13 | 3.23 | 4.22 |
| (13) | (r4/\|r6\|) × 100 | 0.94 | 10.36 | 21.69 | 12.33 |
| (14) | r8/r11 | −0.63 | −1.07 | −0.76 | −1.35 |
| (15) | r11/r12 | 2.48 | 2.67 | 2.85 | 2.24 |
| (16) | r3/f | 4.41 | 3.92 | 4.04 | 3.31 |
| (17) | r4/T2 | 15.72 | 18.05 | 18.39 | 12.04 |
| (18) | \|r5\|/f | 265.73 | 11.66 | 6.64 | 4.05 |
| (19) | \|r6\|/D3 | 2048.50 | 194.73 | 91.78 | 92.38 |
| (20) | r11/f | 0.83 | 0.94 | 1.05 | 0.73 |
| (21) | \|r6\|/r11 | 154.47 | 12.88 | 5.50 | 8.68 |
| (22) | \|r6\|/(T2 + D3) | 922.03 | 91.98 | 44.08 | 47.47 |
| (23) | r12/r11 | 0.40 | 0.37 | 0.35 | 0.45 |
| (24) | r11/D6 | 5.76 | 6.79 | 8.87 | 5.99 |
| (25) | r4/(T2/T1) | 1.26 | 2.26 | 2.22 | 1.43 |

When the imaging lens according to the present invention is adopted to a product with the camera function, there is realized contribution to the low profile and the low F-number of the camera and also high performance thereof.

### DESCRIPTION OF REFERENCE NUMERALS

ST: aperture stop
L1: first lens
L2: second lens
L3: third lens
L4: fourth lens
L5: fifth lens
L6: sixth lens
IR: filter
IMG: imaging plane

What is claimed is:

1. An imaging lens comprising, in order from an object side to an image side,
a first lens with positive refractive power,
a second lens with negative refractive power,
a third lens with positive or negative refractive power,
a fourth lens with positive refractive power,
a fifth lens, and
a sixth lens with negative refractive power,
wherein said first lens has an object-side surface being convex in a paraxial region, and said sixth lens has an image-side surface being concave in a paraxial region, and the following conditional expressions (1), (2), (3) and (4) are satisfied:
11.00<vd3<26.00 (1)
0.10<(r2/|r6|)×100<100.00 (2)
1.60<(|r5/r6|)×100 (3)
0.50<r11/(T4+D5+T5)<6.75 (4)
where
vd3: an abbe number at d-ray of the third lens,
r2: a paraxial curvature radius of an image-side surface of the first lens,
r5: a paraxial curvature radius of an object-side surface of the third lens,
r6: a paraxial curvature radius of an image-side surface of the third lens,
r11: a paraxial curvature radius of an object-side surface of the sixth lens,
T4: a distance along the optical axis from an image-side surface of the fourth lens to an object-side surface of the fifth lens,
D5: a thickness along the optical axis of the fifth lens, and
T5: a distance along the optical axis from an image-side surface of the fifth lens to an object-side surface of the sixth lens.

2. The imaging lens according to claim 1, wherein an object-side surface of said second lens is convex in a paraxial region.

3. The imaging lens according to claim 1, wherein an image-side surface of said second lens is concave in a paraxial region.

4. The imaging lens according to claim 1, wherein an image-side surface of said fourth lens is convex in a paraxial region.

5. The imaging lens according to claim 1, wherein the following conditional expression (5) is satisfied:
0.05<(r2/r4/|r6|)×100<7.00 (5)
where
r2: a paraxial curvature radius of an image-side surface of the first lens,
r4: a paraxial curvature radius of an image-side surface of the second lens, and
r6: a paraxial curvature radius of an image-side surface of the third lens.

6. The imaging lens according to claim 1, wherein the following conditional expression (6) is satisfied:
−5.00<r3/f2<−1.00 (6)
where
r3: a paraxial curvature radius of an object-side surface of the second lens, and
f2: a focal length of the second lens.

7. The imaging lens according to claim 1, wherein the following conditional expression (7) is satisfied:
3.25<r3/(T2/T1)<11.50 (7)
where
r3: a paraxial curvature radius of an object-side surface of the second lens,
T2: a distance along the optical axis from an image-side surface of the second lens to an object-side surface of the third lens, and
T1: a distance along the optical axis from an image-side surface of the first lens to an object-side surface of the second lens.
